(19) United States
(12) Patent Application Publication
(10) Pub. No.: US 2022/0184657 A1
(43) Pub. Date: Jun. 16, 2022

(54) COATING FILM AND METHOD FOR MANUFACTURING SAME

(71) Applicant: SUMITOMO CHEMICAL COMPANY, LIMITED, Tokyo (JP)

(72) Inventors: Sayaka SAKURAI, Tokyo (JP); Masayoshi TOKUDA, Osaka-shi (JP)

(73) Assignee: SUMITOMO CHEMICAL COMPANY, LIMITED, Tokyo (JP)

(21) Appl. No.: 17/603,186

(22) PCT Filed: Apr. 1, 2020
(86) PCT No.: PCT/JP2020/015052

§ 371 Date: Oct. 12, 2021

(30) Foreign Application Priority Data
Apr. 23, 2019 (JP) 2019-081434

(51) Int. Cl. B05D 7/24; B05D 1/36; B05D 3/14

(52) U.S. Cl. CPC B05D 7/24; B05D 1/36; B05D 2518/12; B05D 2203/35; B05D 2350/00; B05D 3/142

(57) ABSTRACT

The present invention aims at providing a coating film excellent in water repellency and oil repellency and further excellent in wear resistance, and a layered body comprising said coating film formed on a base material and a method for manufacturing the same. The present invention provides a coating film having at least an outermost surface layer (M) and a layer (K1) in contact with the layer (M), wherein a density of the layer (M) is 0.7 g/cm³ or more and less than 1.0 g/cm³, and a density of the layer (K1) is 1.0 g/cm³ or more and less than 2.2 g/cm³. The layer (M) preferably has a polydimethylsiloxane skeleton and/or a trialkylsilyl group.

### TECHNICAL FIELD

The present invention relates to a coating film and a method for manufacturing the same and more specifically to a coating film having multiple layers with different densities and a method for manufacturing the same.

### TECHNICAL FIELD

In various display devices, optical elements, semiconductor elements, building materials, automobile components, nanoimprint technique, etc., when a liquid drop (especially, a water drop) attaches to a base material surface, the base material may be stained or corroded, and problems such as performance degradation due to the staining or corrosion may further arise. Therefore, base material surfaces are required to have good water repellency and oil repellency in these fields.

Compositions into which an organic silicon compound is mixed are known as compositions for forming a coating film capable of enhancing water repellency and oil repellency on base material surfaces.

Patent Literature 1 discloses a coating composition obtained by mixing an organic silicon compound in which at least one trialkylsilyl group-containing molecular chain and at least one hydrolyzable group are bonded to a silicon atom and a metal compound in which a hydrolyzable group is bonded to a metal atom. The disclosure of this document indicates that the coating film obtained from said coating composition has good water repellency, oil repellency, light resistance, heat resistance, etc.

Patent Literature 2 discloses a mixed composition of an organic silicon compound having at least one trialkylsilyl group and two or more hydrolyzable silicon groups and a metal compound in which at least one hydrolyzable group is bonded to a metal atom. The disclosure of this document indicates that by virtue of using said composition, a coating film having good heat resistance and light resistance in addition to water repellency can be provided.

### CITATION LIST

### Patent Literature

### Patent Literature 1

International Publication No. WO 2016/068138

### Patent Literature 2

Japanese Patent Laid-Open No. 2017-119849

### SUMMARY OF INVENTION

### Technical Problem

Incidentally, a coating film obtained by using a composition into which an organic silicon compound is mixed may be broken upon receiving friction or the like, which may lead liquid drops to easily adhere thereto and adhering liquid drops to be hardly removed therefrom. However, in Patent Literatures 1 and 2, wear resistance of coating films has not been studied.

The present invention has been completed in view of the above circumstances and aims at providing a coating film excellent in water repellency and oil repellency and further excellent in wear resistance, and a layered body comprising said coating film formed on a base material and a method for manufacturing the same.

### Solution to Problem

[1] A coating film having at least an outermost surface layer (M) and a layer (K1) in contact with the layer (M), wherein a density of the layer (M) is 0.7 g/cm³ or more and less than 1.0 g/cm³, and a density of the layer (K1) is 1.0 g/cm³ or more and less than 2.2 g/cm³.

[2] The coating film according to [1], wherein the layer (M) has a polydimethylsiloxane skeleton.

[3] The coating film according to [1] or [2], wherein the layer (M) has a trialkylsilyl group.

[4] The coating film according to any one of [1] to [3], further having a layer (K2), wherein

the layer (K2) is in contact with a side of the layer (K1) opposite to the layer (M), and

a density of the layer (K2) is 1.1 g/cm³ or less and is smaller than the density of the layer (K1).

[5] The coating film according to any one of [2] to [4], having a polydimethylsiloxane skeleton, wherein silanol groups present on a surface of the coating film after a flowing water test conducted in accordance with JIS Z2371 except that pure water is used instead of salt water is 5 mol % or less based on elements on an outermost surface of the coating film.

[6] The coating film according to any one of [1] to [5], wherein a total thickness of the layer (M) and the layer (K1) is 5 nm or more and 100 nm or less.

[7] A layered body comprising the coating film according to any one of [1] to [6] formed on a base material (S).

[8] A method for manufacturing a layered body comprising a layer (K1) having a density of 1.0 g/cm³ or more and less than 2.2 g/cm³ formed on a base material (S), and a layer (M) having a density of 0.7 g/cm³ or more and less than 1.0 g/cm³ formed, in contact with the layer (K1), on an outermost surface of the layered body, the method comprising:

applying a mixed composition (q) of a polysilazane (F) on the base material (S); before or during curing of the mixed composition (q),

applying a mixed composition (p) of an organic silicon compound (A) having at least one trialkylsilyl group and one or more hydrolyzable silicon groups, an organic silicon compound (B) in which at least one hydrolyzable group is bonded to a silicon atom, and water (C) to a surface coated with the mixed composition (q); and

curing the mixed composition (q) and the mixed composition (p) to form the layer (M) and layer (K1) from a coating layer of the mixed composition (p).

### Advantageous Effect of Invention

The coating film of the present invention is excellent in wear resistance because a layer with a high density is in contact with an outermost surface layer.

### DESCRIPTION OF EMBODIMENTS

The coating film of the present invention is a coating film having at least an outermost surface layer (M) and a layer (K1) in contact with the layer (M), wherein a density of the layer (M) is 0.7 g/cm³ or more and less than 1.0 g/cm³, and a density of the layer (K1) is 1.0 g/cm³ or more and less than 2.2 g/cm³. The coating film of the present invention optionally has one or more additional layers on a side of the layer (K1) opposite to the layer (M) as long as the coating film of the present invention has the layer (M) and the layer (K1).

### Layer (M)

The layer (M) is a layer located at the outermost surface of the coating film of the present invention and has a density of 0.7 g/cm³ or more and less than 1.0 g/cm³. The density of the layer (M) is preferably 0.75 g/cm³ or more and more preferably 0.8 g/cm³ or more and preferably 0.97 g/cm³ or less, more preferably 0.95 g/cm³ or less, and still more preferably 0.9 g/cm³ or less.

The layer (M) preferably has a trialkylsilyl group and/or a siloxane skeleton (preferably, a polydimethylsiloxane skeleton), preferably has at least a polydimethylsiloxane skeleton, and more preferably has both a polydimethylsiloxane skeleton and a trialkylsilyl group. In addition, the layer (M) preferably has water repellency. In addition, a thickness of the layer (M) is, for example, 1.5 nm or more, preferably 2.5 nm or more, and more preferably 3 nm or more and, for example, 30 nm or less, preferably 20 nm or less, and more preferably 10 nm or less.

### Layer (K1)

The layer (K1) is in contact with the layer (M), and the density of the layer (K1) is 1.0 g/cm³ or more and less than 2.2 g/cm³. By virtue of the layer (K1) having such a high density and in contact with the layer (M), wear resistance of the coating film can be improved. The density of the layer (K1) is preferably 1.05 g/cm³ or more and more preferably 1.2 g/cm³ or more and preferably 2.0 g/cm³ or less and more preferably 1.8 g/cm³ or less.

The layer (K1) preferably includes a siloxane and more preferably includes SiO₂. In addition, a thickness of the layer (K1) is, for example, 2 nm or more, preferably 5 nm or more, and more preferably 10 nm or more and, for example, 80 nm or less, preferably 50 nm or less, and more preferably 30 nm or less.

A total thickness of the layer (M) and layer (K1) is preferably 5 nm or more, more preferably 10 nm or more, and still more preferably 20 nm or more and preferably 100 nm or less, more preferably 80 nm or less, and still more preferably 50 nm or less.

The coating film of the present invention optionally has an additional layer (K2) in contact with a side of the layer (K1) opposite to the layer (M).

### Layer (K2)

A density of the layer (K2) is 1.1 g/cm³ or less and is smaller than the density of the layer (K1). The density of the layer (K2) is preferably 1.05 g/cm³ or less and more preferably 1.0 g/cm³ or less. A lower limit of the density of the layer (K2) is 0.7 g/cm³, for example. The layer (K2) preferably includes a structure derived from a polysilazane and preferably includes a structure derived from structural unit (f1) described later (for example, a structure formed by decomposition of structural unit (f1)) as the structure derived from a polysilazane. In addition, the layer (K2) more preferably includes a structure derived from an organic polysilazane; the structure derived from an organic polysilazane includes a structure derived from structural unit (f2) described later and more specifically, includes a silicon atom to which a hydrocarbon group having 1 to 10 carbon atoms is bonded; and it is preferable that a silicon atom to which nitrogen is bonded is included together with a silicon atom to which a hydrocarbon group having 1 to 10 carbon atoms is bonded. The hydrocarbon group having 1 to 10 carbon atoms is preferably an unsubstituted saturated aliphatic hydrocarbon group having 1 to 10 carbon atoms, more preferably an unsubstituted linear saturated aliphatic hydrocarbon group having 1 to 6 carbon atoms, still more preferably a methyl group, an ethyl group, a propyl group, or a butyl group, and especially preferably a methyl group.

A thickness of the layer (K2) is, for example, 2 nm or more, may be 4 nm or more, and may be 5 nm or more and is, for example, 40 nm or less, may be 30 nm or less, and may be 25 nm or less.

A total thickness of the coating film of the present invention is, for example, 10 nm or more, preferably 15 nm or more, and more preferably 20 nm or more and is, for example, 130 nm or less, preferably 110 nm or less, and more preferably 90 nm or less.

The coating film of the present invention has a polydimethylsiloxane skeleton, and silanol groups present on a surface of the coating film after conducting a flowing water test with a salt spray test instrument is preferably 5 mol % or less based on elements on an outermost surface of the coating film. The flowing water test is conducted in accordance with JIS Z2371 except that pure water is used instead of salt water. When a coating film having a siloxane skeleton comes into contact with water, depolymerization thereof proceeds to generate silanol groups and the film dissolves, which may deteriorate performance such as water repellency and wear resistance; however, in the coating film of the present invention, the amount of silanol groups can be reduced even after the flowing water test, and deterioration of water repellency and wear resistance after the flowing water test can be suppressed. The proportion of silanol groups is preferably 3 mol % or less, more preferably 1 mol % or less, still more preferably 0.80 mol % or less, and especially preferably 0.7 mol % or less, and a lower limit thereof is not particularly limited but is 0.1 mol %, for example. After the flowing water test, a water contact angle of the coating film of the present invention evaluated by the method in the examples described later can be 90° or more (usually, 105° or less), and a slipping speed can be 5 mm/second or more (preferably 10 mm/second or more, more preferably 20 mm/second or more, and usually 50 mm/second or less).

In addition, the water contact angle of the coating film of the present invention which is, for example, measured in the manner as shown in the examples described later is preferably 95° or more, more preferably 100° or more, and still more preferably 102° or more and usually 115° or less. It is also preferable that the coating film of the present invention is excellent in slipping properties of a liquid drop (especially, a water drop), and a slipping speed of a water drop measured in the manner as in the examples described later is preferably 10 mm/second or more, more preferably 20 mm/second or more, and still more preferably 30 mm/second or more and usually 90 mm/second or less. Furthermore, wear resistance of the coating film of the present invention determined according to the measurement method in the examples described later is preferably 800 cycles or more, more preferably 1200 cycles or more, still more preferably 1600 cycles or more, and especially preferably 2000 cycles or more, and an upper limit is usually about 4000 cycles.

A layered body comprising the coating film of the present invention described above formed on a base material (S) is also included in the present invention. In a layered body comprising the coating film at least having the layer (M) and layer (K1) according to the present invention formed on a base material (S), the base material (S) and the layer (K1) may be in contact with each other, or another layer such as the layer (K2) may be formed between the base material (S) and the layer (K1).

### Base Material (S)

A shape of the base material (S) may be flat or curved and may be a three-dimensional structure with multiple planes combined.

Similarly, material of the base material (S) is not limited, and the base material (S) may be composed of either an organic material or an inorganic material. Examples of the organic material include thermoplastic resin such as acrylic resin, polycarbonate resin, polyester resin, styrene resin, acryl-styrene copolymerized resin, cellulose resin, and polyolefin resin; thermosetting resin such as phenolic resin, urea formaldehyde resin, melamine resin, epoxy resin, unsaturated polyesters, silicone resin, and urethane resin; etc. Examples of the inorganic material include ceramics; glass; a metal such as iron, silicon, copper, zinc, and aluminum; an alloy including said metal; etc.

The densities and thicknesses of the layer (M), layer (K1), and layer (K2) described above can be calculated using X-ray reflectometry. X-ray reflectometry is a measurement method utilizing interference vibration of X-rays reflected by the interface at which layers with different densities contact.

Such X-ray reflectometry (XRR) enables analyses on the density and film thickness of each layer by observing the phenomenon of reflected X-rays interfering mainly at each interface with a film as described above, and fitting the measurement result using simulation calculation data. The densities of the layer (M), layer (K1), and layer (K2) described above mean values obtained by fitting processing, and when the coating film is fitted to multiple layers as a result of fitting processing, the density of the layer closest to the base material is the density of the coating film on the base material side. The term fitting herein means correction of the difference in spectrum intensity between a calculated theoretical value and an actually measured value with respect to an X-ray spectrum detected, in X-ray measurement.

The density of a layer having a thickness of several tens of nanometers from the outermost surface can be calculated from a total reflection critical angle, and the densities of other layers can be calculated from magnitude of interference fringe amplitude. In addition, the thickness of each layer can be calculated from a vibration cycle.

Procedures of fitting processing will be specifically described below. First, measurement data are obtained from X-rays incident from an angle near the critical angle with respect to the surface of a coating film sample including multiple layers. When the number of data measurement points is denoted by Np, and the angle of incident X-rays at a certain measurement point n is denoted by α(n), a reflective index R{α(n)} of X-rays at the incident angle α(n) is obtained by observing intensity of reflected X-rays at each α(n) varying from 0.050 to 5° followed by normalization by intensity of incident X-rays. A correlation diagram of α(n) with respect to R{α(n)} is referred to as an XRR profile. Measurement is required to be carried out under appropriate conditions according to substrates and film thicknesses of samples, and the appropriate conditions specifically include a measurement range of the angle α(n) of incident X-rays and a divergence angle [° ] of incident X-rays.

At α(n), an angle at which measurement starts must satisfy conditions under which incident X-rays are totally reflected. The conditions under which X-rays are totally reflected can be usually estimated from an elemental species and density, and the total reflection critical angle is said to be 0.230 for a glass substrate, Si substrate, etc. Further, it is more preferable that an angle at which measurement is ended is an angle at which signal intensity becomes almost the same as a background.

With respect to the divergence angle of incident X-rays, it is known that the thicker the film thickness of a film on a substrate, the shorter the X-ray interference pitch [° ] becomes, and the thicker the film thickness is, the smaller the divergence angle [° ] of incident X-rays should be. Usually, it is said that when the thickness of a film is 100 nm or more, the divergence angle should be 0.015° or less, and when the thickness of a film is 300 nm or more, the divergence angle should be 0.003° or less. In order to make the divergence angle 0.015° or less, there is a method of reflecting X-rays once with a dispersive crystal such as Ge(110), for example. Further, in order to make the divergence angle 0.003° or less, there is a method of reflecting X-rays twice with a dispersive crystal such as Ge(110), for example. These dispersive crystals greatly decrease incident intensity when X-rays are reflected. Therefore, it is preferable that the dispersive crystal is not introduced beyond necessity.

The density of the film sample is determined by initializing, with respect to each of the substrate and multilayered coating film, parameters of the film thickness, density, and roughness (interface between air and a film, interface between films, and interface between a film and a substrate) for an actually measured profile obtained from the measurement as described above and performing fitting with at least one or more of these parameters varied (referred to as a simulation calculation profile obtained by simulation calculation) so that this simulation calculation profile becomes close to the actually measured profile.

As a procedure of fitting processing, analysis by the least-squares method is used, for example. Parameters that minimize the residual sum of squares between the simulation calculation profile and actually measured profile are determined. They are a set of parameters best fitted to measurement data.

The residual sum of squares (χ²) is a difference in spectrum intensity between a calculated reflective index (Ical) and an experimental reflective index (Iexp), is represented by expression (Y), and is desirably 0.01 or less. Here, Np is the number of data points within a fitting range, and αᵢ is an angle of incident X-rays.

$$\begin{matrix}[ Expression 1 ] & \\ {𝒳}^{2} = {\sum }_{i = 0}^{{N}_{p}} {[ log \{ {I}_{exp} ( {α}_{i} ) \} - log \{ {I}_{cal} ( {α}_{i} ) \} ]}^{2} & ( Y )\end{matrix}$$

The fitting processing described above can be analyzed by using analysis software (GlobalFit) manufactured by Rigaku Corporation, for example.

As described above, a film species, type, film thickness, and film density of a formed coating film can be measured according to X-ray reflectometry (XRR).

Next, a method for manufacturing a layered body comprising the coating film of the present invention described above formed on a base material (S) will be described.

The layered body is namely a layered body comprising a layer (K1) having a density of 1.0 g/cm³ or more and less than 2.2 g/cm³ formed on a base material (S), and a layer (M) having a density of 0.7 g/cm³ or more and less than 1.0 g/cm³ formed, in contact with the layer (K1), on an outermost surface. In a method for manufacturing such a layered body, a mixed composition (q) of a polysilazane (F) is firstly applied onto the base material (S) and a mixed composition (p) described later is applied before or during curing of the mixed composition (q). Application of the mixed composition (p) before or during curing of the mixed composition (q) can be realized by applying the mixed composition (p) after leaving to stand still for 1 minute to 20 minutes (preferably, 1 minute to 10 minutes) at ordinary temperature (20° C. to 40° C.), for example.

After applying the mixed composition (p), the mixed composition (q) and mixed composition (p) are cured to form the layer (M) and layer (K1) from the coating layer of the mixed composition (p), and the layered body of the present invention can be manufactured thereby. Curing of the mixed compositions (q) and (p) after applying the mixed composition (p) can be realized by leaving to stand still for 30 minutes to 48 hours (preferably one hour to 30 hours and more preferably one hour to six hours) at ordinary temperature (20° C. to 40° C.), for example.

The mixed composition (p) is a composition in which an organic silicon compound (A) having at least one trialkylsilyl group and one or more hydrolyzable silicon groups, an organic silicon compound (B) in which at least one hydrolyzable group is bonded to a silicon atom, and water (C) are mixed. The manufacturing method of the present invention is characterized in that the mixed composition (p) is applied before or during curing of the mixed composition (q) and the mixed compositions (q) and (p) are cured thereafter. By doing so, the layered body is easily manufactured at ordinary temperature. While a mechanism enables manufacturing of the layered body at ordinary temperature is not limited, it is presumed that the following phenomenon occurs, for example. After the mixed composition (q) is applied onto the base material (S), the polysilazane (F) reacts with moisture in the air, a Si—NR—Si bond is decomposed to form a Si—O—Si bond, and ammonia and hydrogen are generated at this time. In addition, the organic silicon compounds (A) and (B) used for the mixed composition (p) each have a hydrolyzable group (preferably, a hydrolyzable group bonded to a silicon atom), and curing of the mixed composition (p) proceeds through generation of a hydroxy group from the hydrolyzable group (preferably, generation of a silanol group from a silicon atom to which the hydrolyzable group is bonded) followed by condensation of the hydroxy group (preferably, silanol group). When the mixed composition (p) is applied before or during curing of the mixed composition (q), ammonia generated during curing of the mixed composition (q) acts as a condensation catalyst for the hydroxy group (preferably, silanol group) in the mixed composition (p). In addition, water generated through condensation reaction of the mixed composition (p) can accelerate decomposition reaction of the mixed composition (q), and ammonia generated through curing of the mixed composition (q) and water generated through curing of the mixed composition (p) can mutually accelerate curing of the mixed compositions, making manufacturing of the layered body at ordinary temperature easy.

In addition, in curing the mixed composition (p), the organic silicon compounds (A) and (B) having specific gravity different from each other separate into two layers (the upper layer is the organic silicon compound (A), and the lower layer is the organic silicon compound (B)), and the layer (M) derived from the organic silicon compound (A) and the layer (K1) derived from the organic silicon compound (B) are formed from the mixed composition (p).

From the coating layer of the mixed composition (q), only the layer (K1) may be formed, or the layer (K1) and layer (K2) may be formed, which can be controlled by preparing a composition of the polysilazane (F) used for the mixed composition (q) or an amount of water in the mixed composition (p). In addition, it is more preferable that a part of a component derived from the mixed composition (p) is compatible with the mixed composition (q) to form the layer (K1). Improvement in wear resistance is expected as binding in the mixed composition (q) and the mixed composition (p) proceeds.

Incidentally, the mixed composition (p) is a composition in which the organic silicon compound (A), the organic silicon compound (B), and water (C) are mixed and is obtained by mixing said (A), (B), and (C) (the same is true for a case where a component other than (A), (B), and (C) is mixed). The mixed composition (q) is a composition in which the polysilazane (F) is mixed and is obtained by mixing said (F) (the same is true for a case where a component other than (F) is mixed). The mixed compositions (p) and (q) both include one in which reaction has proceeded after mixing, for example, during storage.

Examples of an application method of the mixed compositions (p) and (q) include a spin coating method, a dip coating method, a spray coating method, a roll coating method, a bar coating method, hand coating (a method in which a cloth or the like is soaked in a liquid and the liquid is rubbed into the base material), pouring (a method of directly pouring a liquid over the base material using a dropper or the like for application), atomizing (a method of application against the base material using an atomizer), etc. In particular, a spin coating method, a spray coating method, hand coating, pouring, and atomizing are preferable from the viewpoint of workability.

In addition, before the mixed composition (q) is applied to the base material (S), the base material (S) is optionally subjected to treatment for facilitating adhesion in advance. Examples of the treatment for facilitating adhesion include hydrophilic treatment such as corona treatment, plasma treatment, and ultraviolet treatment. In addition, primer treatment by resin, a silane coupling agent, tetraalkoxysilane, etc. is optionally carried out.

Next, the organic silicon compound (A) having at least one trialkylsilyl group and one or more hydrolyzable silicon groups, the organic silicon compound (B) in which at least one hydrolyzable group is bonded to a silicon atom, and water (C) used for the mixed composition (p) will be respectively described.

### 1. Organic Silicon Compound (A)

The organic silicon compound (A) used for the mixed composition (p) has at least one trialkylsilyl group and one or more hydrolyzable silicon groups (that is, a silicon group to which a hydrolyzable group is bonded).

More preferably, examples of the organic silicon compound (A) include an organic silicon compound (A1) in which at least one trialkylsilyl group-containing molecular chain and at least one hydrolyzable group are bonded to a silicon atom (hereinafter, sometimes referred to as the central silicon atom) and an organic silicon compound (A2) having at least one trialkylsilyl group and two or more hydrolyzable silicon groups.

### 1-1. Organic Silicon Compound (A1)

The trialkylsilyl group-containing molecular chain is a monovalent group having a structure in which a trialkylsilyl-containing group is bonded to a terminal of the molecular chain, and water repellency and oil repellency of a coating film formed from the mixed composition (p) are improved because the trialkylsilyl-containing group is bonded to the molecular chain. In a preferred aspect, by virtue of the trialkylsilyl group-containing molecular chain present, friction between liquid drops (water drops or the like) and the coating film is reduced to cause liquid drops to easily move, and slipping properties of water drops improve. In addition, also in a case where an alkyl group of the trialkylsilyl-containing group is replaced by a fluoroalkyl group, water repellency and oil repellency (preferably, plus slipping properties of water drops) at an interface (surface) of the coating film can be similarly improved.

The number of carbon atoms of an alkyl group (per one alkyl group) included in the trialkylsilyl-containing group is preferably 1 to 4, more preferably 1 to 3, and still more preferably 1 or 2.

In the trialkylsilyl group-containing molecular chain, the molecular chain to which the trialkylsilyl-containing group is bonded is preferably linear or branched and more preferably linear.

The molecular chain to which the trialkylsilyl-containing group is bonded preferably includes a dialkylsiloxane chain and more preferably includes a linear dialkylsiloxane chain. In addition, the molecular chain including a dialkylsiloxane chain optionally includes a divalent hydrocarbon group. Even when a part of said molecular chain is a divalent hydrocarbon group, the obtained coating film has good chemical and physical durability because the residual part is a dialkylsiloxane chain.

In the organic silicon compound (A1), the number of trialkylsilyl group-containing molecular chains bonded to the central silicon atom is one or more, preferably three or less, and more preferably two or less. The number of trialkylsilyl group-containing molecular chains bonded to the central silicon atom is especially preferably one.

The hydrolyzable group is a group providing a hydroxy group (a group bonded to a silicon atom to become a silanol group) by hydrolysis, and preferable examples thereof can include an alkoxy group having 1 to 4 carbon atoms such as a methoxy group, an ethoxy group, a propoxy group, and a butoxy group; a hydroxy group; an acetoxy group; a chlorine atom; an isocyanate group; etc. Among them, an alkoxy group having 1 to 4 carbon atoms is preferable, and an alkoxy group having 1 or 2 carbon atoms is more preferable.

In the organic silicon compound (A1), the number of hydrolyzable groups bonded to the central silicon atom is one or more and preferably two or more and preferably three or less in general.

A siloxane skeleton-containing group (preferably, a siloxane skeleton-containing group with the number of atoms less than the number of atoms constituting the molecular chain of the trialkylsilyl group-containing molecular chain) or a hydrocarbon chain-containing group (preferably, a hydrocarbon chain-containing group containing a hydrocarbon chain with the number of carbon atoms less than the number of atoms constituting the molecular chain of the trialkylsilyl group-containing molecular chain) is optionally bonded to the central silicon atom of the organic silicon compound (A1) besides the trialkylsilyl group-containing molecular chain and hydrolyzable group. The hydrocarbon chain-containing group means a group having a hydrocarbon group at least a part thereof.

Two or more kinds of the organic silicon compound (A1) may be used.

Specifically, the organic silicon compound (A1) is preferably a compound represented by formula (a1) below.

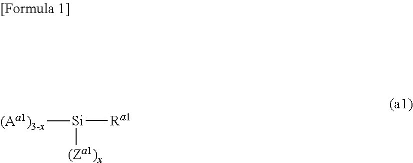

[In formula (a1), multiple A^{a1}s each independently represent a hydrolyzable group; Z^{a1} represents a trialkylsilyl group-containing molecular chain, a siloxane skeleton-containing group, or a hydrocarbon chain-containing group; x is 0 or 1; and R^{a1} represents a trialkylsilyl group-containing molecular chain. A hydrogen atom included in the trialkylsilyl group of Z^{a1} and R^{a1} is optionally substituted with a fluorine atom.]

In formula (a1) above, multiple A^{a1}s are each independently a hydrolyzable group, which may be any group as long as it is a group providing a hydroxy group by hydrolysis (a group bonded to a silicon atom to become a silanol group), and preferable examples thereof can include an alkoxy group having 1 to 4 carbon atoms such as a methoxy group, an ethoxy group, a propoxy group, and a butoxy group; a hydroxy group; an acetoxy group; a chlorine atom; an isocyanate group; etc. Among them, an alkoxy group having 1 to 4 carbon atoms is preferable, and an alkoxy group having 1 or 2 carbon atoms is more preferable.

In formula (a1) above, R^{a1} is a trialkylsilyl group-containing molecular chain, which is a monovalent group having a structure in which a trialkylsilyl-containing group is bonded to a terminal of the molecular chain as described above. The trialkylsilyl-containing group is a group including at least one trialkylsilyl group and preferably a group including two or more trialkylsilyl groups and more preferably three trialkylsilyl groups.

The trialkylsilyl-containing group is preferably a group represented by formula (s1) below.

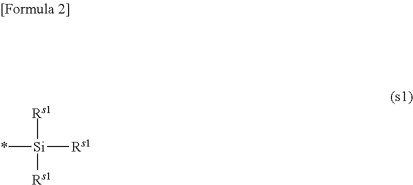

[In formula (s1) above, multiple R^{s1}s each independently represent a hydrocarbon group or a trialkylsilyloxy group, and a hydrogen atom included in the hydrocarbon group or the trialkylsilyloxy group is optionally substituted with a fluorine atom. The symbol * represents a bond.]

In formula (s1) above, it is preferable that at least one R^{s1} is a trialkylsilyloxy group or all R^{s1}s are alkyl groups.

When R^{s1} above is a hydrocarbon group, the number of carbon atoms thereof is preferably 1 to 4, more preferably 1 to 3, and still more preferably 1 or 2.

When R^{s1} above is a hydrocarbon group, R^{s1} is preferably an aliphatic hydrocarbon group and more preferably an alkyl group. Examples of the alkyl group include a methyl group, an ethyl group, a propyl group, a butyl group, etc.

The multiple R^{s1}s may be the same or different and preferably the same. When all R^{s1}s are each a hydrocarbon group (especially, an alkyl group), the total number of carbon atoms of three R^{s1}s is preferably 9 or less, more preferably 6 or less, and still more preferably 4 or less. It is preferable that at least one of three R^{s1}s is a methyl group, it is more preferable that at least two R^{s1}s are methyl groups, and it is especially preferable that all three R^{s1}s are methyl groups.

In formula (s1) above, it is preferable that at least one R^{s1} is a trialkylsilyloxy group.

The trialkylsilyloxy group means a group in which an oxygen atom is bonded to a silicon atom to which three alkyl groups are bonded (trialkylsilyl group). In formula (s1) above, it is preferable that two or more R^{s1}s are trialkylsilyloxy groups, and it is more preferable that three R^{s1}s are trialkylsilyloxy groups (especially, trimethylsilyloxy groups).

In the trialkylsilyl group-containing molecular chain, the trialkylsilyl-containing group is preferably bonded to a terminal (free end side) of the molecular chain, especially to a terminal (free end side) of the main chain (longest linear chain) of the molecular chain.

The molecular chain to which the trialkylsilyl-containing group is bonded is preferably linear or branched and more preferably linear.

The molecular chain to which the trialkylsilyl-containing group is bonded preferably includes a dialkylsiloxane chain and more preferably includes a linear dialkylsiloxane chain. In addition, the molecular chain including a dialkylsiloxane chain may include a divalent hydrocarbon group. Even when a part of the molecular chain is a divalent hydrocarbon group, the obtained coating film has good chemical and physical durability because the residual part is a dialkylsiloxane chain.

The molecular chain to which the trialkylsilyl-containing group is bonded is preferably a group represented by formula (s2) below.

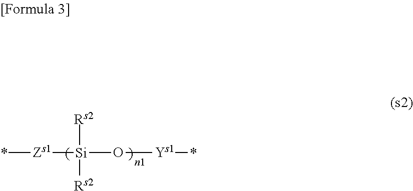

[In formula (s2), Z^{s1} represents —O— or a divalent hydrocarbon group, with —CH₂— included in the divalent hydrocarbon group being optionally replaced by —O—; multiple R^{s2}s each independently represent an alkyl group having 1 to 10 carbon atoms; n1 is an integer of 1 or more; and Y^{s1} represents a single bond or —Si(R^{s2}) 2-L^{s1}-, wherein L^{s1} represents a divalent hydrocarbon group, with —CH₂— included in the divalent hydrocarbon group being optionally replaced by —O—. In formula (s2) above, the symbol * on the left side represents a bond with the central silicon atom, and the symbol * on the right side represents a bond with the trialkylsilyl-containing group.]

The number of carbon atoms in the alkyl group represented by R^{s2} above is preferably 1 to 4, more preferably 1 to 3, and still preferably 1 or 2, and R^{s2} is especially preferably a methyl group.

The denotation n1 is preferably an integer of 1 to 100, more preferably an integer of 1 to 80, still more preferably an integer of 1 to 60, especially preferably an integer of 1 to 50, and most preferably an integer of 1 to 30.

The number of carbon atoms of the divalent hydrocarbon group represented by Z^{s1} or L^{s1} is preferably 1 to 10, more preferably 1 to 6, and still more preferably 1 to 4. The divalent hydrocarbon group is preferably chained, and when the divalent hydrocarbon group is chained, it may be linear or branched. In addition, the divalent hydrocarbon group is preferably a divalent aliphatic hydrocarbon group, and preferably an alkanediyl group. Examples of the divalent hydrocarbon group include a methylene group, an ethylene group, a propylene group, a butylene group, etc.

Furthermore, a part of —CH₂— moieties included in the divalent hydrocarbon group is optionally replaced by —O—. In this case, successive two —CH₂— moieties are not simultaneously replaced by —O—, and —CH₂— adjacent to a Si atom is not replaced by —O—. When two or more —CH₂-moieties are replaced by —O—, the number of carbon atoms between —O— and —O— is preferably 2 to 4 and more preferably 2 or 3. Specifically, as a group in which a part of the divalent hydrocarbon group is replaced by —O—, a group having a (poly)ethylene glycol unit, a group having a (poly)propylene glycol unit, and the like can be exemplified.

In formula (s2) above, it is preferable that Z^{s1} is —O— and Y^{s1} is a single bond, that is, the molecular chain preferably consists only of repetition of dialkylsilyloxy groups. When the dialkylsiloxane chain consists only of repetition of dialkylsilyloxy groups (especially, dimethylsilyloxy groups are preferable), the obtained coating film has good chemical and physical durability.

In addition, the total number of atoms constituting the trialkylsilyl group-containing molecular chain is preferably 24 or more, more preferably 40 or more, still more preferably 50 or more, and further preferably 100 or more, and an upper limit of a preferable range is 5000 or less, 4000 or less, 2000 or less, 1200 or less, 700 or less, 400 or less, and 250 or less in turn.

In formula (a1) above, Z^{a1} represents a trialkylsilyl group-containing molecular chain, a siloxane skeleton-containing group, or a hydrocarbon chain-containing group.

When Z^{a1} is a trialkylsilyl group-containing molecular chain, those same as in R^{a1} above are exemplified.

When Z^{a1} is a siloxane skeleton-containing group, the siloxane skeleton-containing group is a monovalent group containing a siloxane unit (Si—O—), and the number of atoms constituting the siloxane skeleton-containing group is preferably less than the number of atoms constituting the trialkylsilyl group-containing molecular chain of R^{ai} Hence, the siloxane skeleton-containing group becomes a group which has a length shorter than the trialkylsilyl group-containing molecular chain or which is sterically less spread (less bulky). The siloxane skeleton-containing group optionally includes a divalent hydrocarbon group.

The siloxane skeleton-containing group is preferably a group represented by formula (s4) below.

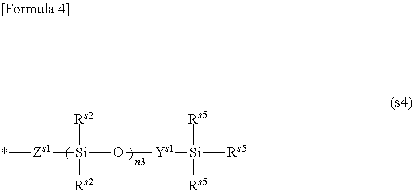

[In formula (s4), Z^{s1}, R^{s2}, and Y^{s1} have the same meanings as described above. R^{s5} represents a hydrocarbon group or a hydroxy group, with —CH₂— included in the hydrocarbon group being optionally replaced by —O—, and a hydrogen atom included in the hydrocarbon group being optionally substituted with a fluorine atom. The denotation n3 represents an integer of 0 to 5. The symbol * represents a bond with the central silicon atom.]

The hydrocarbon group represented by R^{s5} includes the same groups as in the hydrocarbon represented by R^{s1} and is preferably an aliphatic hydrocarbon group and more preferably an alkyl group.

The number of carbon atoms in the hydrocarbon group represented by R^{s5} is preferably 1 to 4, and more preferably 1 to 3, and still more preferably 1 or 2.

The denotation n3 is preferably an integer of 1 to 5 and more preferably an integer of 1 to 3.

The total number of atoms of the siloxane skeleton-containing group is preferably 600 or less, more preferably 500 or less, still more preferably 350 or less, further preferably 100 or less, still further preferably 50 or less, and especially preferably 30 or less and preferably 10 or more. In addition, a difference in the number of atoms between the trialkylsilyl group-containing molecular chain of R^{a1} and the siloxane skeleton-containing group of Z^{a1} is preferably 10 or more and more preferably 20 or more and preferably 1000 or less, more preferably 500 or less, and still more preferably 200 or less.

When Z^{a1} is a hydrocarbon chain-containing group, the number of carbon atoms of its hydrocarbon chain moiety is preferably less than the number of atoms constituting the molecular chain of the trialkylsilyl group-containing molecular chain. In addition, the number of carbon atoms of the longest linear chain of the hydrocarbon chain is preferably less than the number of atoms constituting the longest linear chain of the trialkylsilyl group-containing molecular chain. The hydrocarbon chain-containing group usually constitutes only of a hydrocarbon group (hydrocarbon chain) but may be a group in which a methylene group (—CH₂—) in a part of this hydrocarbon chain is replaced by an oxygen atom if needed. In addition, a methylene group (—CH₂—) adjacent to a Si atom is not replaced by an oxygen atom, and successive two methylene groups (—CH₂—) are not simultaneously replaced by oxygen atoms.

Incidentally, the number of carbon atoms in the hydrocarbon chain moiety means the number of carbon atoms constituting the hydrocarbon group (hydrocarbon chain) for a hydrocarbon chain-containing group unsubstituted with oxygen and means the number of carbon atoms counted under the assumption that an oxygen atom is a methylene group (—CH₂—) for an oxygen-substituted hydrocarbon chain-containing group.

Hereinafter, unless otherwise stated, the hydrocarbon chain-containing group will be described by way of a hydrocarbon chain-containing group unsubstituted with oxygen (that is, a monovalent hydrocarbon group) as an example; however, a part of methylene groups (—CH₂—) thereof can be replaced by an oxygen atom in any description.

When the hydrocarbon chain-containing group is a hydrocarbon group, the number of carbon atoms thereof is preferably one or more and three or less and more preferably one. In addition, the hydrocarbon chain-containing group may be branched or linear. The hydrocarbon chain-containing group is preferably a saturated or unsaturated aliphatic hydrocarbon chain-containing group and more preferably a saturated aliphatic hydrocarbon chain-containing group. The saturated aliphatic hydrocarbon chain-containing group is more preferably a saturated aliphatic hydrocarbon group. Examples of the saturated aliphatic hydrocarbon group include a methyl group, an ethyl group, a propyl group, etc.

When a part of methylene groups (—CH₂—) of the saturated aliphatic hydrocarbon group is replaced by an oxygen atom, a group having a (poly)ethylene glycol unit, and the like can be specifically exemplified.

In formula (a1) above, x is preferably 0.

Specifically, the organic silicon compound (A1) includes a compound represented by formula (A-I).

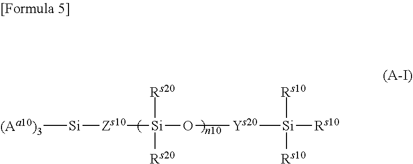

In formula (A-I) above, A^{a10}, Z^{s10}, R^{s20}, n10, Y^{s10}, and R^{s10} are preferably combinations shown in Tables 1-1, 1-2, 2-1, and 2-2 below.

TABLE 1-1

| | A^{a10} | Z^{s10} | R^{s20} | n10 | y^{s10} | R^{s10} |
|---|---|---|---|---|---|---|
| (A-I-1) | C₂H₅O—* | *—O—* | CH₃—* | 1~60 | — | (CH₃)₃SiO—* |
| (A-I-2) | C₂H₅O—* | *—O—* | CH₃—* | 1~60 | *—Si(CH₃)₂—CH₂—* | (CH₃)₃SiO—* |
| (A-I-3) | C₂H₅O—* | *—O—* | CH₃—* | 1~60 | *—Si(CH₃)₂—(CH₂)₂—* | (CH₃)₃SiO—* |
| (A-I-4) | C₂H₅O—* | *—O—* | CH₃—* | 1~60 | *—Si(CH₃)₂—(CH₂)₃—* | (CH₃)₃SiO—* |
| (A-I-5) | C₂H₅O—* | *—O—* | CH₃—* | 1~60 | *—Si(CH₃)₂—(CH₂)₄—* | (CH₃)₃SiO—* |
| (A-I-6) | C₂H₅O—* | *—CH₂—* | CH₃—* | 1~60 | — | (CH₃)₃SiO—* |
| (A-I-7) | C₂H₅O—* | *—CH₂—* | CH₃—* | 1~60 | *—Si(CH₃)₂—CH₂—* | (CH₃)₃SiO—* |
| (A-I-8) | C₂H₅O—* | *—CH₂—* | CH₃—* | 1~60 | *—Si(CH₃)₂—(CH₂)₂—* | (CH₃)₃SiO—* |
| (A-I-9) | C₂H₅O—* | *—CH₂—* | CH₃—* | 1~60 | *—Si(CH₃)₂—(CH₂)₃—* | (CH₃)₃SiO—* |
| (A-I-10) | C₂H₅O—* | *—CH₂—* | CH₃—* | 1~60 | *—Si(CH₃)₂—(CH₂)₄—* | (CH₃)₃SiO—* |
| (A-I-11) | C₂H₅O—* | *—(CH₂)₂—* | CH₃—* | 1~60 | — | (CH₃)₃SiO—* |
| (A-I-12) | C₂H₅O—* | *—(CH₂)₂—* | CH₃—* | 1~60 | *—Si(CH₃)₂—CH₂—* | (CH₃)₃SiO—* |
| (A-I-13) | C₂H₅O—* | *—(CH₂)₂—* | CH₃—* | 1~60 | *—Si(CH₃)₂—(CH₂)₂—* | (CH₃)₃SiO—* |
| (A-I-14) | C₂H₅O—* | *—(CH₂)₂—* | CH₃—* | 1~60 | *—Si(CH₃)₂—(CH₂)₃—* | (CH₃)₃SiO—* |
| (A-I-15) | C₂H₅O—* | *—(CH₂)₂—* | CH₃—* | 1~60 | *—Si(CH₃)₂—(CH₂)₄—* | (CH₃)₃SiO—* |
| (A-I-16) | C₂H₅O—* | *—(CH₂)₃—* | CH₃—* | 1~60 | — | (CH₃)₃SiO—* |
| (A-I-17) | C₂H₅O—* | *—(CH₂)₃—* | CH₃—* | 1~60 | *—Si(CH₃)₂—CH₂—* | (CH₃)₃SiO—* |
| (A-I-18) | C₂H₅O—* | *—(CH₂)₃—* | CH₃—* | 1~60 | *—Si(CH₃)₂—(CH₂)₂—* | (CH₃)₃SiO—* |
| (A-I-19) | C₂H₅O—* | *—(CH₂)₃—* | CH₃—* | 1~60 | *—Si(CH₃)₂—(CH₂)₃—* | (CH₃)₃SiO—* |
| (A-I-20) | C₂H₅O—* | *—(CH₂)₃—* | CH₃—* | 1~60 | *—Si(CH₃)₂—(CH₂)₄—* | (CH₃)₃SiO—* |
| (A-I-21) | C₂H₅O—* | *—(CH₂)₄—* | CH₃—* | 1~60 | — | (CH₃)₃SiO—* |
| (A-I-22) | C₂H₅O—* | *—(CH₂)₄—* | CH₃—* | 1~60 | *—Si(CH₃)₂—CH₂—* | (CH₃)₃SiO—* |
| (A-I-23) | C₂H₅O—* | *—(CH₂)₄—* | CH₃—* | 1~60 | *—Si(CH₃)₂—(CH₂)₂—* | (CH₃)₃SiO—* |
| (A-I-24) | C₂H₅O—* | *—(CH₂)₄—* | CH₃—* | 1~60 | *—Si(CH₃)₂—(CH₂)₃—* | (CH₃)₃SiO—* |
| (A-I-25) | C₂H₅O—* | *—(CH₂)₄—* | CH₃—* | 1~60 | *—Si(CH₃)₂—(CH₂)₄—* | (CH₃)₃SiO—* |

TABLE 1-2

| | A^{a10} | Z^{s10} | R^{s20} | n10 | y^{s10} | R^{s10} |
|---|---|---|---|---|---|---|
| (A-I-26) | CH₃O—* | *—O—* | CH₃—* | 1~60 | — | (CH₃)₃SiO—* |
| (A-I-27) | CH₃O—* | *—O—* | CH₃—* | 1~60 | *—Si(CH₃)₂—CH₂—* | (CH₃)₃SiO—* |
| (A-I-28) | CH₃O—* | *—O—* | CH₃—* | 1~60 | *—Si(CH₃)₂—(CH₂)₂—* | (CH₃)₃SiO—* |
| (A-I-29) | CH₃O—* | *—O—* | CH₃—* | 1~60 | *—Si(CH₃)₂—(CH₂)₃—* | (CH₃)₃SiO—* |
| (A-I-30) | CH₃O—* | *—O—* | CH₃—* | 1~60 | *—Si(CH₃)₂—(CH₂)₄—* | (CH₃)₃SiO—* |
| (A-I-31) | CH₃O—* | *—CH₂—* | CH₃—* | 1~60 | — | (CH₃)₃SiO—* |
| (A-I-32) | CH₃O—* | *—CH₂—* | CH₃—* | 1~60 | *—Si(CH₃)₂—CH₂—* | (CH₃)₃SiO—* |
| (A-I-33) | CH₃O—* | *—CH₂—* | CH₃—* | 1~60 | *—Si(CH₃)₂—(CH₂)₂—* | (CH₃)₃SiO—* |
| (A-I-34) | CH₃O—* | *—CH₂—* | CH₃—* | 1~60 | *—Si(CH₃)₂—(CH₂)₃—* | (CH₃)₃SiO—* |
| (A-I-35) | CH₃O—* | *—CH₂—* | CH₃—* | 1~60 | *—Si(CH₃)₂—(CH₂)₄—* | (CH₃)₃SiO—* |
| (A-I-36) | CH₃O—* | *—(CH₂)₂—* | CH₃—* | 1~60 | — | (CH₃)₃SiO—* |
| (A-I-37) | CH₃O—* | *—(CH₂)₂—* | CH₃—* | 1~60 | *—Si(CH₃)₂—CH₂—* | (CH₃)₃SiO—* |
| (A-I-38) | CH₃O—* | *—(CH₂)₂—* | CH₃—* | 1~60 | *—Si(CH₃)₂—(CH₂)₂—* | (CH₃)₃SiO—* |
| (A-I-39) | CH₃O—* | *—(CH₂)₂—* | CH₃—* | 1~60 | *—Si(CH₃)₂—(CH₂)₃—* | (CH₃)₃SiO—* |
| (A-I-40) | CH₃O—* | *—(CH₂)₂—* | CH₃—* | 1~60 | *—Si(CH₃)₂—(CH₂)₄—* | (CH₃)₃SiO—* |
| (A-I-41) | CH₃O—* | *—(CH₂)₃—* | CH₃—* | 1~60 | — | (CH₃)₃SiO—* |
| (A-I-42) | CH₃O—* | *—(CH₂)₃—* | CH₃—* | 1~60 | *—Si(CH₃)₂—CH₂—* | (CH₃)₃SiO—* |
| (A-I-43) | CH₃O—* | *—(CH₂)₃—* | CH₃—* | 1~60 | *—Si(CH₃)₂—(CH₂)₂—* | (CH₃)₃SiO—* |
| (A-I-44) | CH₃O—* | *—(CH₂)₃—* | CH₃—* | 1~60 | *—Si(CH₃)₂—(CH₂)₃—* | (CH₃)₃SiO—* |
| (A-I-45) | CH₃O—* | *—(CH₂)₃—* | CH₃—* | 1~60 | *—Si(CH₃)₂—(CH₂)₄—* | (CH₃)₃SiO—* |
| (A-I-46) | CH₃O—* | *—(CH₂)₄—* | CH₃—* | 1~60 | — | (CH₃)₃SiO—* |
| (A-I-47) | CH₃O—* | *—(CH₂)₄—* | CH₃—* | 1~60 | *—Si(CH₃)₂—CH₂—* | (CH₃)₃SiO—* |
| (A-I-48) | CH₃O—* | *—(CH₂)₄—* | CH₃—* | 1~60 | *—Si(CH₃)₂—(CH₂)₂—* | (CH₃)₃SiO—* |
| (A-I-49) | CH₃O—* | *—(CH₂)₄—* | CH₃—* | 1~60 | *—Si(CH₃)₂—(CH₂)₃—* | (CH₃)₃SiO—* |
| (A-I-50) | CH₃O—* | *—(CH₂)₄—* | CH₃—* | 1~60 | *—Si(CH₃)₂—(CH₂)₄—* | (CH₃)₃SiO—* |

TABLE 2-1

| | A^{a10} | Z^{s10} | R^{s20} | n10 | y^{s10} | R^{s10} |
|---|---|---|---|---|---|---|
| (A-I-51) | C₂H₅O—* | *—O—* | CH₃—* | 1~60 | — | CH₃—* |
| (A-I-52) | C₂H₅O—* | *—O—* | CH₃—* | 1~60 | *—Si(CH₃)₂—CH₂—* | CH₃—* |
| (A-I-53) | C₂H₅O—* | *—O—* | CH—* | 1~60 | *—Si(CH₃)₂—(CH₂)₂—* | CH₃—* |
| (A-I-54) | C₂H₅O—* | *—O—* | CH₃—* | 1~60 | *—Si(CH₃)₂—(CH₂)₃—* | CH₃—* |
| (A-I-55) | C₂H₅O—* | *—O—* | CH₃—* | 1~60 | *—Si(CH₃)₂—(CH₂)₄—* | CH₃—* |
| (A-I-56) | C₂H₅O—* | *—CH₂—* | CH₃—* | 1~60 | — | CH₃—* |
| (A-I-57) | C₂H₅O—* | *—CH₂—* | CH₃—* | 1~60 | *—Si(CH₃)₂—CH₂—* | CH₃—* |
| (A-I-58) | C₂H₅O—* | *—CH₂—* | CH₃—* | 1~60 | *—Si(CH₃)₂—(CH₂)₂—* | CH₃—* |
| (A-I-59) | C₂H₅O—* | *—CH₂—* | CH₃—* | 1~60 | *—Si(CH₃)₂—(CH₂)₃—* | CH₃—* |
| (A-I-60) | C₂H₅O—* | *—CH₂—* | CH₃—* | 1~60 | *—si(CH₃)₂—(CH₂)₄—* | CH₃—* |
| (A-I-61) | C₂H₅O—* | *—(CH₂)₂—* | CH₃—* | 1~60 | — | CH₃—* |
| (A-I-62) | C₂H₅O—* | *—(CH₂)₂—* | CH₃—* | 1~60 | *—Si(CH₃)₂—CH₂—* | CH₃—* |
| (A-I-63) | C₂H₅O—* | *—(CH₂)₂—* | CH₃—* | 1~60 | *—Si(CH₃)₂—(CH₂)₂—* | CH₃—* |
| (A-I-64) | C₂H₅O—* | *—(CH₂)₂—* | CH₃—* | 1~60 | *—Si(CH₃)₂—(CH₂)₃—* | CH₃—* |
| (A-I-65) | C₂H₅O—* | *—(CH₂)₂—* | CH₃—* | 1~60 | *—Si(CH₃)₂—(CH₂)₄—* | CH₃—* |
| (A-I-66) | C₂H₅O—* | *—(CH₂)₃—* | CH₃—* | 1~60 | — | CH₃—* |
| (A-I-67) | C₂H₅O—* | *—(CH₂)₃—* | CH₃—* | 1~60 | *—Si(CH₃)₂—CH₂—* | CH₃—* |
| (A-I-68) | C₂H₅O—* | *—(CH₂)₃—* | CH₃—* | 1~60 | *—Si(CH₃)₂—(CH₂)₂—* | CH₃—* |
| (A-I-69) | C₂H₅O—* | *—(CH₂)₃—* | CH₃—* | 1~60 | *—Si(CH₃)₂—(CH₂)₃—* | CH₃—* |
| (A-I-70) | C₂H₅O—* | *—(CH₂)₃—* | CH₃—* | 1~60 | *—Si(CH₃)₂—(CH₂)₄—* | CH₃—* |
| (A-I-71) | C₂H₅O—* | *—(CH₂)₄—* | CH₃—* | 1~60 | — | CH₃—* |
| (A-I-72) | C₂H₅O—* | *—(CH₂)₄—* | CH₃—* | 1~60 | *—Si(CH₃)₂—CH₂—* | CH₃—* |
| (A-I-73) | C₂H₅O—* | *—(CH₂)₄—* | CH₃—* | 1~60 | *—Si(CH₃)₂—(CH₂)₂—* | CH₃—* |
| (A-I-74) | C₂H₅O—* | *—(CH₂)₄—* | CH₃—* | 1~60 | *—Si(CH₃)₂—(CH₂)₃—* | CH₃—* |
| (A-I-75) | C₂H₅O—* | *—(CH₂)₄—* | CH₃—* | 1~60 | *—Si(CH₃)₂—(CH₂)₄—* | CH₃—* |

TABLE 2-2

| | A^{a10} | Z^{s10} | R^{s20} | n10 | y^{s10} | R^{s10} |
|---|---|---|---|---|---|---|
| (A-I-76) | CH₃O—* | *—O—* | CH₃—* | 1~60 | — | CH₃—* |
| (A-I-77) | CH₃O—* | *—O—* | CH₃—* | 1~60 | *—Si(CH₃)₂—CH₂—* | CH₃—* |
| (A-I-78) | CH₃O—* | *—O—* | CH₃—* | 1~60 | *—Si(CH₃)₂—(CH₂)₂—* | CH₃—* |
| (A-I-79) | CH₃O—* | *—O—* | CH₃—* | 1~60 | *—Si(CH₃)₂—(CH₂)₃—* | CH₃—* |
| (A-I-80) | CH₃O—* | *—O—* | CH₃—* | 1~60 | *—Si(CH₃)₂—(CH₂)₄—* | CH₃—* |
| (A-I-81) | CH₃O—* | *—CH₂—* | CH₃—* | 1~60 | — | CH₃—* |
| (A-I-82) | CH₃O—* | *—CH₂—* | CH₃—* | 1~60 | *—Si(CH₃)₂—CH₂—* | CH₃—* |
| (A-I-83) | CH₃O—* | *—CH₂—* | CH₃—* | 1~60 | *—Si(CH₃)₂—(CH₂)₂—* | CH₃—* |
| (A-I-84) | CH₃O—* | *—CH₂—* | CH₃—* | 1~60 | *—Si(CH₃)₂—(CH₂)₃—* | CH₃—* |
| (A-I-85) | CH₃O—* | *—CH₂—* | CH₃—* | 1~60 | *—Si(CH₃)₂—(CH₂)₄—* | CH₃—* |
| (A-I-86) | CH₃O—* | *—(CH₂)₂—* | CH₃—* | 1~60 | — | CH₃—* |
| (A-I-87) | CH₃O—* | *—(CH₂)₂—* | CH₃—* | 1~60 | *—Si(CH₃)₂—CH₂—* | CH₃—* |
| (A-I-88) | CH₃O—* | *—(CH₂)₂—* | CH₃—* | 1~60 | *—Si(CH₃)₂—(CH)₂—* | CH₃—* |
| (A-I-89) | CH₃O—* | *—(CH₂)₂—* | CH₃—* | 1~60 | *—Si(CH₃)₂—(CH₂)₃—* | CH₃—* |
| (A-I-90) | CH₃O—* | *—(CH₂)₂—* | CH₃—* | 1~60 | *—Si(CH₃)₂—(CH₂)₄—* | CH₃—* |
| (A-I-91) | CH₃O—* | *—(CH₂)₃—* | CH₃—* | 1~60 | — | CH₃—* |
| (A-I-92) | CH₃O—* | *—(CH₂)₃—* | CH₃—* | 1~60 | *—Si(CH₃)₂—CH₂—* | CH₃—* |
| (A-I-93) | CH₃O—* | *—(CH₂)₃—* | CH₃—* | 1~60 | *—Si(CH₃)₂—(CH₂)₂—* | CH₃—* |
| (A-I-94) | CH₃O—* | *—(CH₂)₃—* | CH₃—* | 1~60 | *—Si(CH₃)₂—(CH₂)₃—* | CH₃—* |
| (A-I-95) | CH₃O—* | *—(CH₂)₃—* | CH₃—* | 1~60 | *—Si(CH₃)₂—(CH₂)₄—* | CH₃—* |
| (A-I-96) | CH₃O—* | *—(CH₂)₄—* | CH₃—* | 1~60 | — | CH₃—* |
| (A-I-97) | CH₃O—* | *—(CH₂)₄—* | CH₃—* | 1~60 | *—Si(CH₃)₂—CH₂—* | CH₃—* |
| (A-I-98) | CH₃O—* | *—(CH₂)₄—* | CH₃—* | 1~60 | *—Si(CH₃)₂—(CH₂)₂—* | CH₃—* |
| (A-I-99) | CH₃O—* | *—(CH₂)₄—* | CH₃—* | 1~60 | *—Si(CH₃)₂—(CH₂)₃—* | CH₃—* |
| (A-I-100) | CH₃O—* | *—(CH₂)₄—* | CH₃—* | 1~60 | *—Si(CH₃)₂—(CH₂)₄—* | CH₃—* |

In (A-I-1) to (A-I-100) above, n10 is more preferably an integer of 2 or more and still more preferably an integer of 3 or more and more preferably an integer of 50 or less, still more preferably an integer of 40 or less, further preferably an integer of 30 or less, and most preferably an integer of 25 or less.

Among the compounds of formula (A-I), the compound represented by (A-I-26) is preferable. That is, a compound represented by formula (a3) below is preferable as the organic silicon compound (A1).

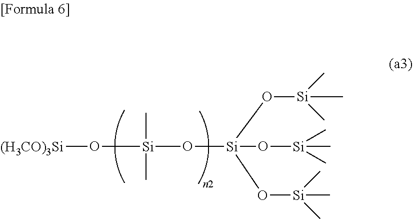

[In formula (a3), n2 is an integer of 1 to 60.]

The denotation n2 is more preferably an integer of 2 or more, still more preferably an integer of 3 or more and more preferably an integer of 50 or less, still more preferably an integer of 40 or less, especially preferably an integer of 30 or less, and most preferably an integer of 25 or less.

An amount of the organic silicon compound (A1) is preferably 0.01% by mass or more, more preferably 0.015% by mass or more, still more preferably 0.02% by mass or more and preferably 0.5% by mass or less, more preferably 0.4% by mass or less, and still more preferably 0.3% by mass or less, with the total amount of the mixed composition (p) taken as 100% by mass. The amount of the organic silicon compound (A1) can be adjusted when the composition is prepared. The amount of the organic silicon compound (A1) may be calculated from an analysis result of the composition. Incidentally, in the present specification, when a range of amount, mass ratio, or mole ratio of each component is described, the range can be adjusted when the composition is prepared in the same manner as described above.

As a method for synthesizing the organic silicon compound (A1), the method described in Japanese Patent Laid-Open No. 2017-201009 is given.

### 1-2. Organic Silicon Compound (A2)

The organic silicon compound (A2) is a compound having at least one trialkylsilyl group and two or more hydrolyzable silicon groups. The number of hydrolyzable silicon groups included in the organic silicon compound (A2) is preferably three or more. In addition, the number of the hydrolyzable silicon groups included in the organic silicon compound (A2) is preferably 20 or less and more preferably 15 or less.

Here, the hydrolyzable silicon group means a group in which a group (hereinafter, sometimes referred to as a “hydrolyzable group”) which can form a silanol group (Si(OH) group) by hydrolysis is bonded to a silicon atom, and is preferably a group in which at least one (preferably two or more, more preferably three) hydrolyzable group is bonded to one silicon atom.

It is preferable that, in the organic silicon compound (A2), the trialkylsilyl group and the hydrolyzable silicon group are bonded to the hydrolyzable silicon group via a chained or cyclic (including a combination of chain and cycle, the same applies hereinafter) hydrocarbon and/or a chained or cyclic dialkylsiloxane. Water repellency due to the trialkylsilyl group is exerted more effectively thereby. Here, the dialkylsiloxane means a molecular chain in which silicon atoms each having two alkyl groups bonded thereto and oxygen atoms are alternatively linked.

The organic silicon compound (A2) is preferably a compound represented by formula (Ia).

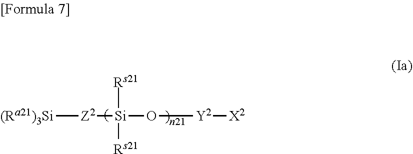

[In formula (Ia), Y² represents a single bond or *—Si(R^{s22})₂-L^{s21}-. The symbol * represents a bond with the oxygen atom. Z² represents an oxygen atom or a divalent hydrocarbon group having 1 to 10 carbon atoms. R^{a21}s each independently represent a hydrocarbon group or a trialkylsilyloxy group. Provided that when all R^{a21}s are hydrocarbon groups, the hydrocarbon group represented by R^{a21} is an alkyl group. R^{s21} and R^{s22} each independently represent an alkyl group having 1 to 10 carbon atoms. L^{s21} represents a divalent hydrocarbon group having 1 to 10 carbon atoms. X² represents a hydrolyzable silicon-containing group having two or more hydrolyzable silicon groups. The denotation n21 represents an integer of 1 or more and 150 or less.]

In formula (Ia) above, the number of carbon atoms of the hydrocarbon group of R^{a21} is preferably 1 to 4, more preferably 1 to 3, and still more preferably 1 to 2. The hydrocarbon group of R^{a21} may be linear or branched and is preferably linear. In addition, the hydrocarbon group of R^{a21} is preferably an aliphatic hydrocarbon group and more preferably an alkyl group. Examples of the hydrocarbon group of R^{a21} include a linear alkyl group such as a methyl group, an ethyl group, a propyl group, and a butyl group.

The number of carbon atoms in the alkyl group included in the trialkylsilyloxy group in R^{a21} is preferably 1 to 4, more preferably 1 to 3, and still more preferably 1 to 2 per one alkyl group. In addition, in the case where all R^{a21}s are alkyl groups, the total number of carbon atoms of three alkyl groups in the (R^{a21})₃Si— group or trialkylsilyloxy group is preferably 9 or less, more preferably 6 or less, and still more preferably 4 or less.

Example of the alkyl group included in the trialkylsilyloxy group include a methyl group, an ethyl group, a propyl group, a butyl group, etc. In addition, in the case where all R^{a21}s are alkyl groups, the three alkyl groups in the (R^{a21})₃Si— group or trialkylsilyloxy group may be the same or different from each other and are preferably the same. Furthermore, in the case where all R^{a21}s are alkyl groups, the (R^{a21})₃Si— group or trialkylsilyloxy group includes preferably one or more alkyl groups (especially, methyl groups), more preferably two or more and especially preferably three alkyl groups.

In the case where all R^{a21}s are alkyl groups, examples of the trialkylsilyl group included in the (R^{a21})₃Si— group or trialkylsilyloxy group include a trialkylsilyl group in which one methyl group is bonded to a silicon atom such as a methyldiethylsilyl group, a methylethylpropylsilyl group, a methylethylbutylsilyl group, a methyldipropylsilyl group, a methylpropylbutylsilyl group, and a methyldibutylsilyl group; a trialkylsilyl group in which two methyl groups are bonded to a silicon atom such as a dimethylethylsilyl group, a dimethylpropylsilyl group, and a dimethylbutylsilyl group; a trimethylsilyl group; etc.

In the (R^{a21})₃Si— group or trialkylsilyloxy group in which all R^{a21}s are alkyl groups, the entire of the alkyl groups included in the trialkylsilyl group may be replaced by a fluoroalkyl group. The fluoroalkyl group includes a group in which at least a part of hydrogen atoms in the alkyl group is substituted with a fluorine atom. The number of carbon atoms in the fluoroalkyl group is preferably 1 to 4, more preferably 1 to 3, and still more preferably 1 to 2. In addition, when the number of carbon atoms is denoted by n_{c}, the number of substituting fluorine atoms is preferably 1 or more and preferably 2×n_{c}+1 or less. Examples of the fluoroalkyl group include a monofluoromethyl group, a difluoromethyl group, a trifluoromethyl group (perfluoromethyl group), a monofluoroethyl group, a difluoroethyl group, a trifluoroethyl group, a tetrafluoroethyl group, a pentafluoroethyl group (perfluoroethyl group), a monofluoropropyl group, a difluoropropyl group, a trifluoropropyl group, a tetrafluoropropyl group, a pentafluoropropyl group, a hexafluoropropyl group, a heptafluoropropyl group (perfluoropropyl group), a monofluorobutyl group, a difluorobutyl group, a trifluorobutyl group, a tetrafluorobutyl group, a pentafluorobutyl group, a hexafluorobutyl group, a heptafluorobutyl group, an octafluorobutyl group, nonafluorobutyl group (perfluorobutyl group), etc.

When an alkyl group is replaced by a fluoroalkyl group, the number of substituting fluoroalkyl groups can be appropriately selected within a range of 1 to 3 per one silicon atom.

R^{a21} is preferably an alkyl group or a trialkylsilyloxy group and more preferably a trialkylsilyloxy group. In addition, it is preferable that two or more R^{a21}s are trialkylsilyloxy groups, and it is more preferable that three R^{a21}s are trialkylsilyloxy groups, out of the multiple R^{a21}s.

Hereinafter, (R^{a21})₃Si—Z²— (Si(R^{s21})₂—O—)ₙ₂₁—Y²— is sometimes referred to as a trialkylsilyl group-containing molecular chain.

Y² above may be *—Si(R^{s22})₂-L^{s21}- (provided that L^{s21} represents a divalent hydrocarbon group having 1 to 10 carbon atoms), and Z² may be a hydrocarbon group having 1 to 10 carbon atoms. Even when a hydrocarbon group is included, since the residual part is a dialkylsiloxane chain, a coating film which has high chemical and physical durability and is excellent in heat resistance and light resistance is provided. When L^{s21} or Z² is a divalent hydrocarbon group, the number of carbon atoms thereof is preferably 8 or less, more preferably 6 or less, and still more preferably 4 or less and preferably 1 or more. The divalent hydrocarbon group is preferably chained, and when the divalent hydrocarbon group is chained, it may be linear or branched. In addition, the divalent hydrocarbon group is preferably a divalent aliphatic hydrocarbon group and more preferably an alkylene group. Examples of the divalent hydrocarbon group include an alkylene group such as a methylene group, an ethylene group, a propylene group, and a butylene group.

Furthermore, a part of methylene groups (—CH₂—) in the divalent hydrocarbon group in L^{s21} or Z² is optionally replaced by an oxygen atom or —Si(R^{L})₂—O— if needed. R^{L} above is a hydrogen atom or a hydrocarbon group having 1 to 10 carbon atoms, preferably a linear aliphatic hydrocarbon group, more preferably an alkyl group, and still more preferably an alkyl group having 1 to 4 carbon atoms. Provided that successive two methylene groups (—CH₂—) are not simultaneously replaced by oxygen atoms, and it is preferable that a methylene group (—CH₂—) adjacent to a Si atom is not replaced by an oxygen atom.

Z² is preferably an oxygen atom. When X₂ is a group represented by formula (X-2) described later, Y² is preferably *—Si(R^{s22})₂-L^{s21}-, with a part of methylene groups (—CH₂—) of the divalent hydrocarbon group in L^{s21} replaced by —Si(R^{L})₂—O— described above, and when X² is a group represented by formula (X-3) described later, Y² is preferably a group represented by *—Si(R^{s22})₂-L^{s21}-.

The number of carbon atoms of the alkyl group of R^{s21} and R^{s22} is preferably 1 to 4, more preferably 1 to 3, and still more preferably 1 to 2. Examples of the alkyl group of R^{s21} and R^{s22} include a methyl group, an ethyl group, a propyl group, a butyl group, etc. Examples of the dialkylsiloxane chain represented by —(Si(R^{s21})₂—O—)ₙ₂₁— include a (poly)dimethylsiloxane chain, a (poly)diethylsiloxane chain, etc.

The denotation n21 is 1 or more; preferably 150 or less, more preferably 100 or less, still more preferably 60 or less, and especially preferably 50 or less; and preferably 3 or more.

In addition, the number of atoms constituting the longest linear chain included in —Z²— (Si(R^{s21})₂—O—)ₙ₂₁—Y²— is preferably 2 or more, more preferably 6 or more, and still more preferably 15 or more and preferably 1200 or less, more preferably 700 or less, and still more preferably 500 or less.

The hydrolyzable silicon-containing group of X² may be a group having two or more hydrolyzable silicon groups and is preferably a group in which hydrolyzable silicon groups are bonded to a chained or cyclic base moiety, for example. The base moiety is preferably a hydrocarbon and/or (poly)dialkylsiloxane.

X² is preferably a group represented by any of formulae (X-1) to (X-3).

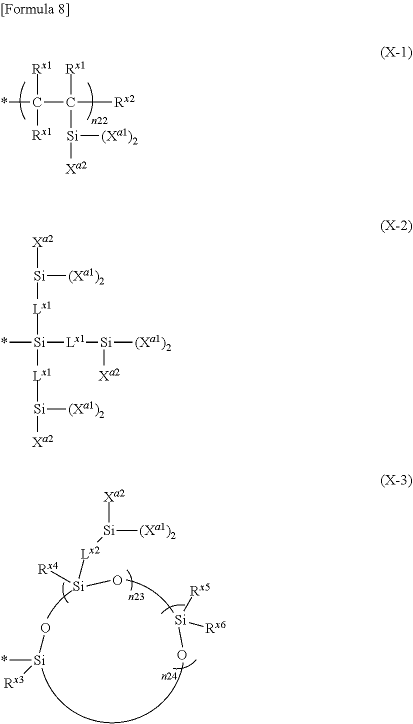

[In formulae (X-1) to (X-3), Lx1 and L^{x2} each represent a divalent hydrocarbon group having 1 to 20 carbon atoms, and a methylene group (—CH₂—) included in the divalent hydrocarbon group is optionally replaced by —O— or —O—Si(R^{x7})₂—.

R^{x1} to R^{x7} each represent a hydrogen atom or a hydrocarbon group having 1 to 10 carbon atoms.

X^{a1}s each independently represent a hydrolyzable group or a trialkoxysilyloxy group.

X^{a2}s each independently represent a hydrolyzable group, a trialkoxysilyloxy group, a hydrocarbon chain-containing group, a siloxane skeleton-containing group, or a trialkylsilyl group-containing molecular chain, and when X^{a2} is a hydrolyzable group or a trialkoxysilyloxy group, X^{a2} and X^{a1} may be the same or different.

The denotation n22 represents an integer of 2 or more and 20 or less.

The denotation n23 represents an integer of 2 or more and 5 or less.

The denotation n24 represents an integer of 0 or more and 5 or less.

In formula (X-3), the order of the units represented by (Si(R^{x4}) (-L^{x2}-Si(X^{a2}) (Xₐ₁)₂)—O—) and (Si(R^{x5}) (R^{x6})—O—) is arbitrary.]

The number of carbon atoms in the divalent hydrocarbon group of L^{x1} and L^{x2} is preferably 10 or less, more preferably 6 or less, and still more preferably 4 or less and preferably 1 or more. The divalent hydrocarbon group of L^{x1} and L^{x2} is preferably chained and may be linear or branched. The divalent hydrocarbon group of L^{x1} and L^{x2} is preferably a divalent aliphatic hydrocarbon group and more preferably an alkylene group. Examples of the divalent hydrocarbon group of L^{x1} and L^{x2} include an alkylene group such as a methylene group, an ethylene group, a propylene group, and a butylene group.

When a methylene group (—CH₂—) included in the divalent hydrocarbon group of L^{x1} and L^{x2} is replaced by —O— or —Si(R^{x7})₂—O—, it is preferable that the methylene group (—CH₂—) closest to the trialkylsilyl group (preferably, trimethylsilyl group) included in (R^{a21})₃Si— is replaced among methylene groups (—CH₂—) included in L^{x1} and L^{x2}. In addition, the methylene group (—CH₂—) directly bonded to —Si(X^{a1})₂(X^{a2}) may be or may not be replaced by —O— or —Si(R^{x7})₂—O—, and it is preferable that the methylene group (—CH₂—) directly bonded to —Si(X^{a1})₂(X^{a2}) is not replaced.

Examples of L^{x1} and L^{x2} can include the following groups. Provided that the symbol * represents a bond, and the symbol * on the left side is the side closer to the trialkylsilyl group (preferably, trimethylsilyl group) included in (R^{a21})₃Si.

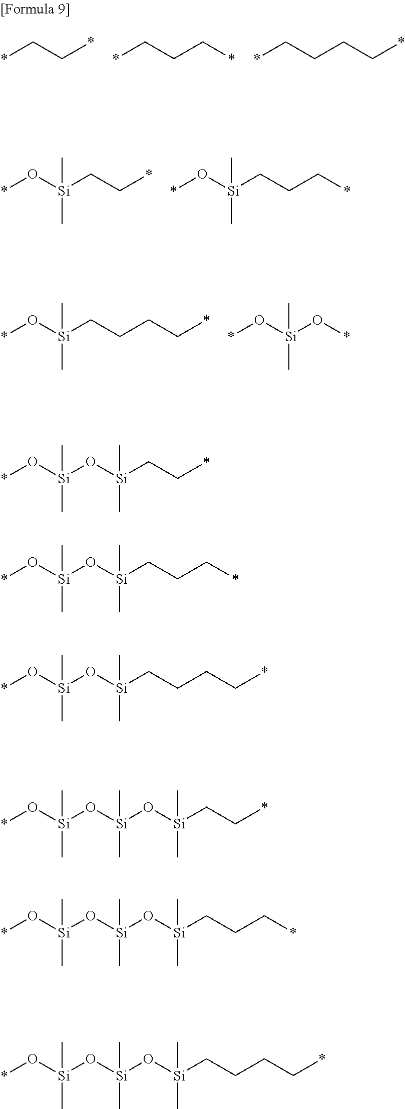

The number of carbon atoms in the hydrocarbon group of R^{x1} to R^{x7} is preferably 1 to 8, more preferably 1 to 6, and still more preferably 1 to 4. The hydrocarbon group of R^{x1} to R^{x7} may be chained or cyclic and may be linear or branched. The hydrocarbon group of R^{x1} to R^{x7} is preferably an aliphatic hydrocarbon group and more preferably an alkyl group. Examples of the hydrocarbon group of R^{x1} to R^{x7} include an alkyl group such as a methyl group, an ethyl group, a propyl group, a butyl group, a pentyl group, a hexyl group, a heptyl group, and an octyl group.

Examples of the hydrolyzable group of X^{a1} and X^{a2} include an alkoxy group having 1 to 4 carbon atoms such as a methoxy group, an ethoxy group, a propoxy group, and a butoxy group; a hydroxy group; an acetoxy group; a chlorine atom; an isocyanate group; etc., and an alkoxy group and an isocyanate group are preferable.

The alkoxy groups included in the trialkoxysilyloxy group of X^{a1} and X^{a2} may be the same or different and examples thereof include an alkoxy group having 1 to 4 carbon atoms such as a methoxy group, an ethoxy group, a propoxy group, and a butoxy group. A trimethoxysilyloxy group and triethoxysilylgroup are especially preferable as the trialkoxysilyloxy group of X^{a1} and X^{a2}.

The hydrocarbon chain-containing group of X^{a2} contains a hydrocarbon chain and means a group with the number of atoms constituting this hydrocarbon chain less than the number of atoms of the chained or cyclic hydrocarbon and/or chained or cyclic dialkylsiloxane linking the trialkylsilyl group and the hydrolyzable silicon group. In addition, it is preferable that the number of carbon atoms of the longest linear chain of the hydrocarbon chain is less than the number of atoms of the trialkylsilyl group-containing molecular chain. The hydrocarbon chain-containing group usually consists only of a hydrocarbon group (hydrocarbon chain) but may be a group in which a part of methylene groups (—CH₂—) in this hydrocarbon chain is replaced by an oxygen atom, if needed. In addition, the methylene group (—CH₂—) adjacent to a Si atom is not replaced by an oxygen atom, and successive two methylene groups (—CH₂—) are not simultaneously replaced by oxygen atoms.

Incidentally, the number of carbon atoms of a hydrocarbon chain moiety means the number of carbon atoms constituting the hydrocarbon group (hydrocarbon chain) for a hydrocarbon chain-containing group unsubstituted with oxygen and means the number of carbon atoms counted on the assumption that an oxygen atom is a methylene group (—CH₂—) for an oxygen-substituted hydrocarbon chain-containing group.

Hereinafter, unless otherwise stated, the hydrocarbon chain-containing group will be described by way of a hydrocarbon chain-containing group unsubstituted with oxygen (that is, a monovalent hydrocarbon group) as an example; however, a part of methylene groups (—CH₂—) thereof can be replaced by an oxygen atom in any description.

The number of carbon atoms of the hydrocarbon chain-containing group is preferably 1 to 3 and more preferably 1 when the hydrocarbon chain-containing group is a hydrocarbon group. In addition, the hydrocarbon chain-containing group (in the case of a hydrocarbon group) may be branched or linear. The hydrocarbon chain-containing group (in the case of a hydrocarbon group) is preferably a saturated or unsaturated aliphatic hydrocarbon chain-containing group and more preferably a saturated aliphatic hydrocarbon chain-containing group. An alkyl group such as a methyl group, an ethyl group, and a propyl group are more preferable as the saturated aliphatic hydrocarbon chain-containing group (in the case of a hydrocarbon group).

As the group in which a part of methylene groups (—CH₂—) in the saturated aliphatic hydrocarbon group is replaced by an oxygen atom, a group having a (poly)ethylene glycol unit can be exemplified, for example.

The siloxane skeleton-containing group of X^{a2} may be a group containing a siloxane unit (Si—O—) and consisting of atoms less than the number of atoms constituting the chained or cyclic hydrocarbon and/or chained or cyclic dialkylsiloxane linking the trialkylsilyl group and the hydrolyzable silicon group. Hence, the siloxane skeleton-containing group becomes a group which has a length shorter than the trialkylsilyl group-containing molecular chain or which is sterically less spread (less bulky).

In addition, the siloxane skeleton-containing group is preferably chained and may be linear or branched. In the siloxane skeleton-containing group, the siloxane unit (Si—O—) is preferably a dialkylsilyloxy group. Examples of the dialkylsilyloxy group include a dimethylsilyloxy group, a diethylsilyloxy group, etc. The number of repetitions of the siloxane unit (Si—O—) is preferably 1 or more and preferably 5 or less and more preferably 3 or less.

The siloxane skeleton-containing group optionally includes a divalent hydrocarbon group in a part of the siloxane skeleton. Specifically, a part of oxygen atoms in the siloxane skeleton is optionally replaced by a divalent hydrocarbon group. The divalent hydrocarbon group which may replace a part of oxygen atoms in the siloxane skeleton can include the same groups as in the divalent hydrocarbon group which may replace an oxygen atom of the dialkylsiloxane chain included in the trialkylsilyl group-containing molecular chain.

In addition, the silicon atom at a terminal (free end) of the siloxane skeleton-containing group optionally has a hydrocarbon group (preferably, an alkyl group) group and the like in addition to the hydrolyzable group for forming a siloxane unit (Si—O—) with an adjacent silicon atom or the like. In this case, the siloxane skeleton-containing group has a trialkylsilyl group but may exert its function as a spacer if the number of atoms thereof is less than that of the coexisting trialkylsilyl group-containing molecular chain. In addition, also in a case where the siloxane skeleton-containing group includes a trialkylsilyl group, an alkyl group of the trialkylsilyl group is optionally replaced by a fluoroalkyl group.

Furthermore, the number of atoms of the siloxane skeleton-containing group is preferably 100 or less, more preferably 50 or less, and still more preferably 30 or less and usually 10 or more. In addition, the difference in the number of atoms between the trialkylsilyl group-containing molecular chain and the siloxane skeleton-containing group is preferably 10 or more and more preferably 20 or more and, in usual, preferably 1000 or less, more preferably 500 or less, and still more preferably 200 or less.

The siloxane skeleton-containing group is preferably a group represented by formula (x1).

[Formula 10]

*—(O—Si(R^{x9})₂)ₙ₅—O—Si(R^{x8})₃ (x1)

[In formula (x1), multiple R^{x8}s each independently represent a hydrocarbon group or a hydroxy group. R^{x9}s each independently represent an alkyl group having 1 to 4 carbon atoms. The denotation n5 represents an integer of 0 or more and 4 or less. The symbol * represents a bond with a silicon atom.]

In formula (x1) above, the hydrocarbon group of R^{x8} includes groups same as the groups exemplified as the hydrocarbon group of R^{x1} and is preferably an aliphatic hydrocarbon group and more preferably a linear alkyl group such as a methyl group, an ethyl group, a propyl group, and a butyl group.

In addition, R^{x8} is preferably a hydrocarbon group. A methylene group included in the hydrocarbon group of R^{x8} is optionally replaced by an oxygen atom.

In addition, in formula (x1) above, the alkyl group having 1 to 4 carbon atoms of R^{x9} includes same groups as the groups described for R^{s21} in formula (Ia). The denotation n5 is preferably an integer of 0 or more and 3 or less.

Examples of the siloxane skeleton-containing group include groups represented by the following formulae.

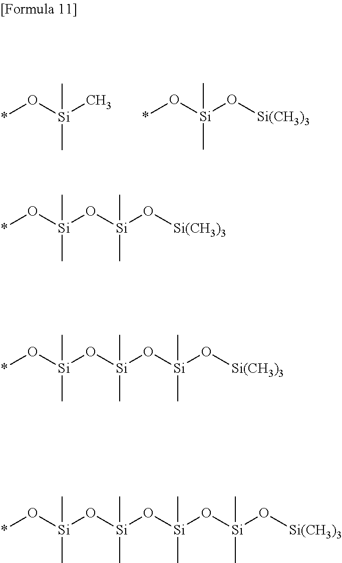

X^{a1} is preferably an alkoxy group or a trialkoxysilyloxy group.

In addition, X^{a2} is preferably a hydrolyzable group or a trialkoxysilyloxy group and is preferably an alkoxy group or a trialkoxysilyloxy group.

The denotation n22 is preferably an integer of 2 or more and 10 or less and more preferably an integer of 2 or more and 8 or less.

The denotation n23 is preferably an integer of 2 or more and 4 or less.

The denotation n24 is preferably an integer of 0 or more and 4 or less.

Groups represented by the following formulae are preferable as X². In the formulae, X^{a3} represents a hydrolyzable group or a trialkoxysilyloxy group, n6 represents an integer of 2 to 10, n7 represents an integer of 1 to 20 (preferably, 1 to 19), and n8 represents an integer of 1 to 20 (preferably, 1 to 18). The symbol * represents a bond with Y².

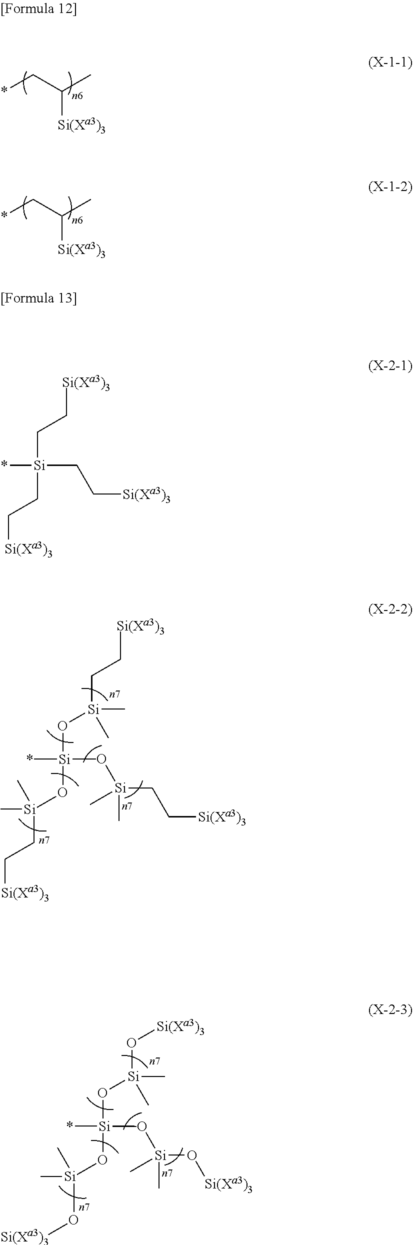

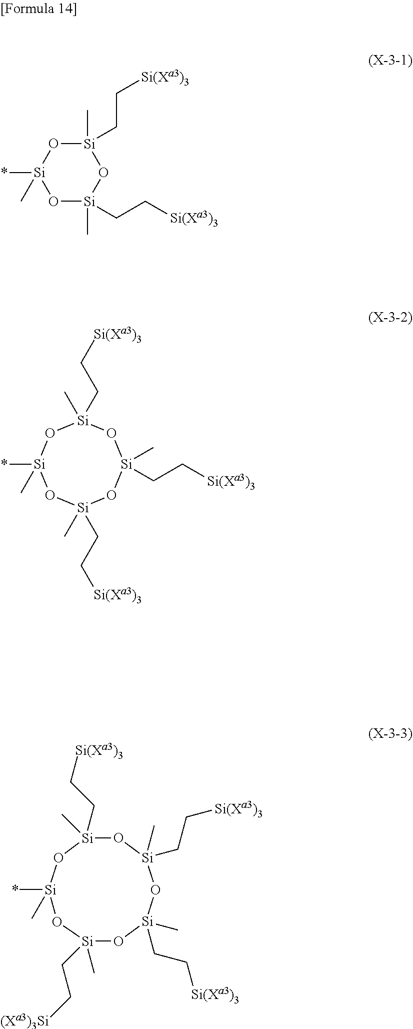

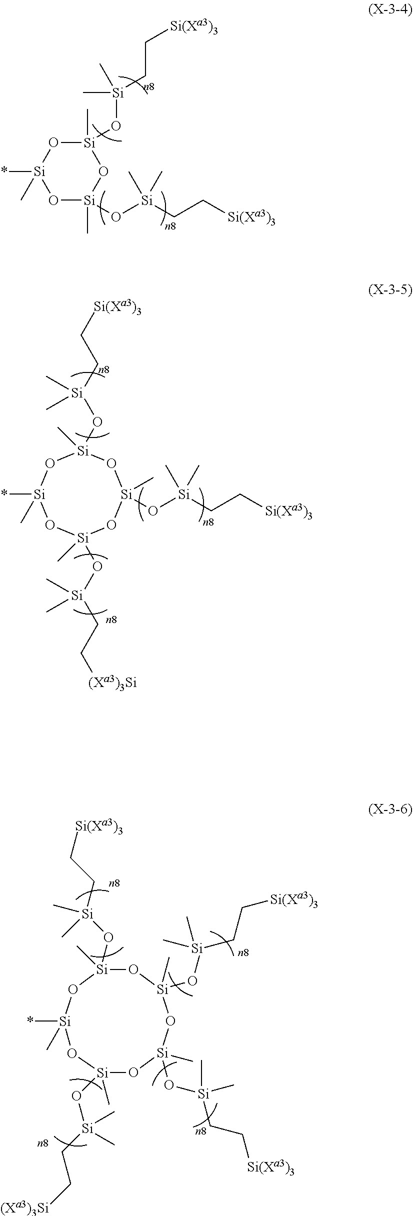

The organic silicon compound (A2) is preferably a compound represented by formula (Ia-1)

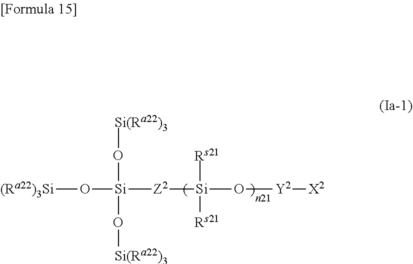

[In formula (Ia-1), Y², Z², R^{s21}, and n21 have the same meanings as described above. R^{a22}s each independently represent an alkyl group having 1 to 4 carbon atoms. X² represents a group represented by any of formulae (X-1) to (X-3).

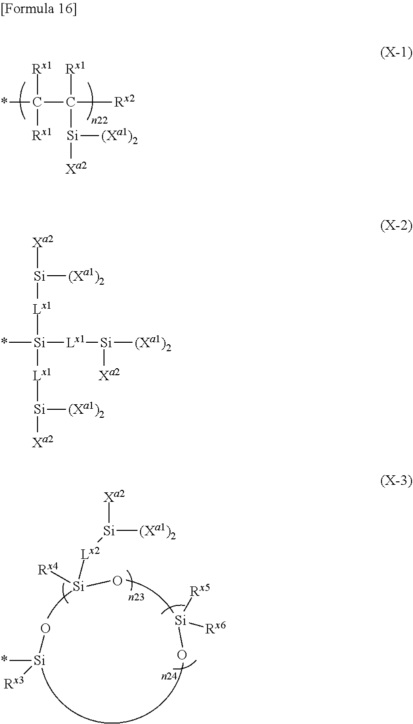

[In formulae (X-1) to (X-3), L^{x1}, L^{x2}, R^{x1} to R^{x6}, X^{a1}, X^{a2}, and n22 to n24 have the same meanings as described above.]

The number of carbon atoms of the alkyl group of R^{a22} is preferably 1 to 3, more preferably 1 to 2, and especially preferably 1. Examples of the alkyl group of R^{a22} include a methyl group, an ethyl group, a propyl group, etc.

Examples of the organic silicon compound (A2) include a compound represented by the following formula. Provided that n20 is preferably an integer of 1 to 30 and more preferably an integer of 1 to 20.

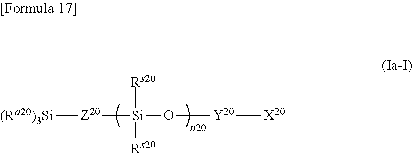

TABLE 3

| Compound | | | | | | |
|---|---|---|---|---|---|---|
| name | R^{a20} | Z²⁰ | R^{s20} | n20 | Y²⁰ | X²⁰ |
| Ia-I-1 | Me | *—O—* | Me | 1~20 | — | (X-1-1) |
| Ia-I-2 | Me | *—O—* | Me | 1~20 | (Y1) | (X-1-1) |
| Ia-I-3 | Me | *—O—* | Me | 1~20 | (Y2) | (X-1-1) |
| Ia-I-4 | Me | *—O—* | Me | 1~20 | (Y3) | (X-1-1) |
| Ia-I-5 | Me | *—O—* | Me | 1~20 | (Y4) | (X-1-1) |
| Ia-I-6 | TMS | *—O—* | Me | 1~20 | — | (X-1-1) |
| Ia-I-7 | TMS | *—O—* | Me | 1~20 | (Y1) | (X-1-1) |
| Ia-I-8 | TMS | *—O—* | Me | 1~20 | (Y2) | (X-1-1) |
| Ia-I-9 | TMS | *—O—* | Me | 1~20 | (Y3) | (X-1-1) |
| Ia-I-10 | TMS | *—O—* | Me | 1~20 | (Y4) | (X-1-1) |
| Ia-I-11 | Me | *—O—* | Me | 1~20 | — | (X-1-2) |
| Ia-I-12 | Me | *—O—* | Me | 1~20 | (Y2) | (X-1-2) |
| Ia-I-13 | TMS | *—O—* | Me | 1~20 | — | (X-1-2) |
| Ia-I-14 | TMS | *—O—* | Me | 1~20 | (Y2) | (X-1-2) |
| Ia-I-15 | Me | *—O—* | Me | 1~20 | — | (X-2-1) |
| Ia-I-16 | Me | *—O—* | Me | 1~20 | (Y1) | (X-2-1) |
| Ia-I-17 | Me | *—O—* | Me | 1~20 | (Y2) | (X-2-1) |
| Ia-I-18 | Me | *—O—* | Me | 1~20 | (Y3) | (X-2-1) |
| Ia-I-19 | Me | *—O—* | Me | 1~20 | (Y4) | (X-2-1) |
| Ia-I-20 | TMS | *—O—* | Me | 1~20 | — | (X-2-1) |
| Ia-I-21 | TMS | *—O—* | Me | 1~20 | (Y1) | (X-2-1) |
| Ia-I-22 | TMS | *—O—* | Me | 1~20 | (Y2) | (X-2-1) |
| Ia-I-23 | TMS | *—O—* | Me | 1~20 | (Y3) | (X-2-1) |
| Ia-I-24 | TMS | *—O—* | Me | 1~20 | (Y4) | (X-2-1) |
| Ia-I-25 | Me | *—O—* | Me | 1~20 | — | (X-2-2) |
| Ia-I-26 | Me | *—O—* | Me | 1~20 | (Y2) or (Y3-2) | (X-2-2) |
| Ia-I-27 | TMS | *—O—* | Me | 1~20 | — | (X-2-2) |
| Ia-I-28 | TMS | *—O—* | Me | 1~20 | (Y2) or (Y3-2) | (X-2-2) |
| Ia-I-29 | Me | *—O—* | Me | 1~20 | — | (X-2-3) |
| Ia-I-30 | Me | *—O—* | Me | 1~20 | (Y2) | (X-2-3) |
| Ia-I-31 | TMS | *—O—* | Me | 1~20 | — | (X-2-3) |
| Ia-I-32 | TMS | *—O—* | Me | 1~20 | (Y2) | (X-2-3) |

TABLE 4

| Compound | | | | | | |
|---|---|---|---|---|---|---|
| name | R^{a20} | z²⁰ | R^{s20} | n20 | Y²⁰ | X²⁰ |
| Ia-I-33 | Me | *—O—* | Me | 1~20 | — | (X-3-1) |
| Ia-I-34 | Me | *—O—* | Me | 1~20 | (Y2) | (X-3-1) |
| Ia-I-35 | TMS | *—O—* | Me | 1~20 | — | (X-3-1) |
| Ia-I-36 | TMS | *—O—* | Me | 1~20 | (Y2) | (X-3-1) |
| Ia-I-37 | Me | *—O—* | Me | 1~20 | — | (X-3-2) |
| Ia-I-38 | Me | *—O—* | Me | 1~20 | (Y1) | (X-3-2) |
| Ia-I-39 | Me | *—O—* | Me | 1~20 | (Y2) | (X-3-2) |
| Ia-I-40 | Me | *—O—* | Me | 1~20 | (Y3) | (X-3-2) |
| Ia-I-41 | Me | *—O—* | Me | 1~20 | (Y4) | (X-3-2) |
| Ia-I-42 | TMS | *—O—* | Me | 1~20 | — | (X-3-2) |
| Ia-I-43 | TMS | *—O—* | Me | 1~20 | (Y1) | (X-3-2) |
| Ia-I-44 | TMS | *—O—* | Me | 1~20 | (Y2) | (X-3-2) |
| Ia-I-45 | TMS | *—O—* | Me | 1~20 | (Y3) | (X-3-2) |
| Ia-I-46 | TMS | *—O—* | Me | 1~20 | (Y4) | (X-3-2) |
| Ia-I-47 | Me | *—O—* | Me | 1~20 | — | (X-3-3) |
| Ia-I-48 | Me | *—O—* | Me | 1~20 | (Y2) | (X-3-3) |
| Ia-I-49 | TMS | *—O—* | Me | 1~20 | — | (X-3-3) |
| Ia-I-50 | TMS | *—O—* | Me | 1~20 | (Y2) | (X-3-3) |
| Ia-I-51 | Me | *—O—* | Me | 1~20 | — | (X-3-4) |
| Ia-I-52 | Me | *—O—* | Me | 1~20 | (Y2) | (X-3-4) |
| Ia-I-53 | TMS | *—O—* | Me | 1~20 | — | (X-3-4) |
| Ia-I-54 | TMS | *—O—* | Me | 1~20 | (Y2) | (X-3-4) |
| Ia-I-55 | Me | *—O—* | Me | 1~20 | — | (X-3-5) |
| Ia-I-56 | Me | *—O—* | Me | 1~20 | (Y2) | (X-3-5) |
| Ia-I-57 | TMS | *—O—* | Me | 1~20 | — | (X-3-5) |
| Ia-I-58 | TMS | *—O—* | Me | 1~20 | (Y2) | (X-3-5) |
| Ia-I-59 | Me | *—O—* | Me | 1~20 | — | (X-3-6) |
| Ia-I-60 | Me | *—O—* | Me | 1~20 | (Y2) | (X-3-6) |
| Ia-I-61 | TMS | *—O—* | Me | 1~20 | — | (X-3-6) |
| Ia-I-62 | TMS | *—O—* | Me | 1~20 | (Y2) | (X-3-6) |

In the tables, Me means a methyl group, and TMS means a trimethylsilyloxy group. (Y1) to (Y4) mean the groups represented by the following formulae, respectively.

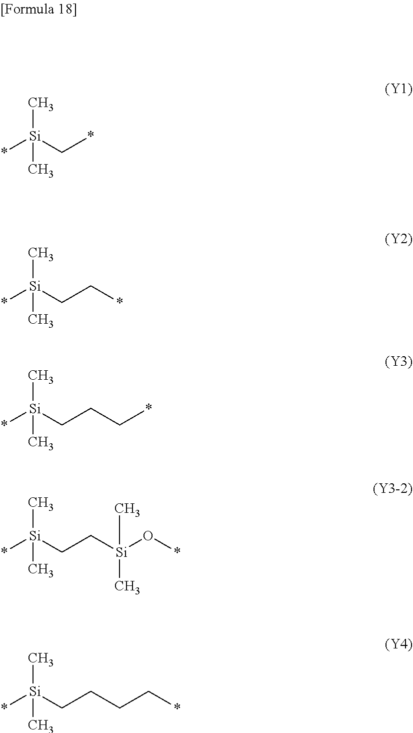

The organic silicon compound (A2) of the present invention can be manufactured by the method described in paragraphs 0076 to 0088 of Japanese Patent Laid-Open No. 2017-119849, for example.

### 2. Organic Silicon Compound (B)

The organic silicon compound (B) used for the mixed composition (p) is a compound in which at least one hydrolyzable group is bonded to a silicon atom, functions as a spacer by mixing with the organic silicon compound (A), and can improve water repellency and oil repellency of a coating film by moderately dispersing the above-described trialkylsilyl group therein.

The organic silicon compound (B) is preferably a compound represented by formula (b1) below.

Si(R^{b10})ᵣ(A^{b1})₄₋ᵣ (b1)

[In formula (b1), R^{b10} represents a siloxane skeleton-containing group, a hydrocarbon chain-containing group, or a hydrogen atom, and r is 0 or 1. Multiple A^{b1}s each independently represent a hydrolyzable group.]

It is considered that water repellency and oil repellency properties of a coating film obtained from the mixed composition (p) are enhanced by the trialkylsilyl group derived from the organic silicon compound (A), and silicon atoms to which such a trialkylsilyl group-containing molecular chain is not bonded function as a spacer in the coating film.

The siloxane skeleton-containing group is a group having a siloxane skeleton-containing group at least in a part thereof, and the hydrocarbon chain-containing group may be a group having a hydrocarbon chain at least in a part thereof.

Incidentally, the siloxane skeleton-containing group of R^{b10} is preferably a group including no dialkylsiloxane chain.

The hydrolyzable group represented by A^{b1} and the siloxane skeleton-containing group and hydrocarbon chain-containing group represented by R^{b10} can be appropriately selected from the hydrolyzable groups, siloxane skeleton-containing groups, and hydrocarbon chain-containing groups described for the organic silicon compound (A), and the preferable ranges thereof are also the same.

Two or more kinds of the organic silicon compound (B) may be used.

The organic silicon compound (B) includes an organic silicon compound B1 in which r=0, that is, only hydrolyzable groups A^{b1} are bonded to the silicon atom thereof; or an organic silicon compound B2 in which r=1, that is, one siloxane skeleton-containing group, hydrocarbon chain-containing group, or hydrogen atom and three hydrolyzable groups A^{b1} are bonded to the silicon atom thereof.

### (Organic Silicon Compound B1)

Examples of the organic silicon compound B1 in which only hydrolyzable groups A^{b1} are bonded to the silicon atom thereof include a tetraalkoxysilane such as tetramethoxysilane, tetraethoxysilane, tetrapropoxysilane, and tetrabutoxysilane.

### (Organic Silicon Compound B2)

Examples of the organic silicon compound B2 in which one siloxane skeleton-containing group, hydrocarbon chain-containing group, or hydrogen atom and three hydrolyzable groups A^{b1} are bonded to the silicon atom thereof include a trimethylsilyloxy trialkoxysilane such as trimethylsilyloxy trimethoxysilane, trimethylsilyloxy triethoxysilane, and trimethylsilyloxy tripropoxysilane; an alkyltrialkoxysilane such as methyltrimethoxysilane, ethyltrimethoxysilane, methyltriethoxysilane, ethyltriethoxysilane, and methyltripropoxysilane; an alkenyltrialkoxysilane such as vinyltrimethoxysilane and vinyltriethoxysilane; and a trialkoxysilane such as trimethoxysilane, triethoxysilane, and tripropoxysilane.

Specifically, the organic silicon compound B2 is preferably a compound represented by formula (b2) below.

Si(OR^{b11})_{y}H_{4-y} (b2)

[In formula (b2), R^{b11} represents an alkyl group having 1 to 6 carbon atoms, and y is 3 or 4.]

Examples of the alkyl group represented by R^{b11} include a methyl group, an ethyl group, a propyl group, a butyl group, a pentyl group, a hexyl group, etc.

The number of carbon atoms of the alkyl group represented by R^{b11} is preferably 1 to 4, more preferably 1 to 3, and still more preferably 1 or 2.

An amount of the organic silicon compound (B) is preferably 0.01% by mass or more, more preferably 0.03% by mass or more, and still more preferably 0.05% by mass or more and preferably 5% by mass or less, more preferably 2% by mass or less, and still more preferably 1% by mass or less, with the total amount of the mixed composition (p) taken as 100% by mass.

A total amount (A+B) of the organic silicon compound (A) and the organic silicon compound (B) is preferably 0.01% by mass or more, more preferably 0.05% by mass or more, and still more preferably 0.08% by mass or more and preferably 3% by mass or less, more preferably 2% by mass or less, and still more preferably 1.5% by mass or less, with the total amount of the mixed composition (p) taken as 100% by mass.

A mole ratio (B/A) of the organic silicon compound (B) to the organic silicon compound (A) is preferably 2 to 500. The mole ratio (B/A) is more preferably 8 or more, still more preferably 10 or more, especially preferably 15 or more, and most preferably 20 or more and more preferably 200 or less, still more preferably 100 or less, and especially preferably 50 or less.

Water (D) is mixed into the mixed composition (p) besides the organic silicon compound (A) and organic silicon compound (B), and it is preferable that a catalyst (C) and a solvent (E) are mixed into the mixed composition (p) if needed.

### 3. Catalyst (C)

In adjusting the mixed composition (p), a catalyst (C) that acts as a hydrolysis and condensation catalyst for hydrolyzable groups bonded to a silicon atom optionally coexists with the organic silicon compound (A) and organic silicon compound (B). An acid, alkali, etc. can be used as the catalyst (C), and it is preferable to use an acid among them. The acid may be an inorganic acid or an organic acid, and it is especially preferable to use an organic acid in view of ease of control of hydrolysis and condensation reaction. By virtue of using an acid as the catalyst (C) and suppressing an amount of water mixed into the composition as described later, reaction during formation of a liquid-repellent film can be caused to mildly proceed and a superior liquid-repellent film can be formed.

Specifically, examples of the acid include nitric acid, hydrochloric acid, maleic acid, phosphoric acid, malonic acid, formic acid, benzoic acid, phenylethanoic acid, acetic acid, butanoic acid, 2-methylpropanoic acid, propanoic acid, 2,2-dimethylpropanoic acid, etc. and is preferably an organic acid and more preferably maleic acid (pKa=1.92), formic acid (pKa=3.75), or acetic acid (pKa=4.76).

Only one kind of the catalyst (C) may be used, or two or more kinds thereof may be used in combination.

An amount of the catalyst (C) based on the total of the organic silicon compound (A) and organic silicon compound (B) as 100% by mass (catalyst (C)/{organic silicon compound (A)+organic silicon compound (B)}) is preferably 0.05% by mass or more, more preferably 0.1% by mass or more, and still more preferably 1% by mass or more and preferably 20% by mass or less, more preferably 18% by mass or less, and still more preferably 13% by mass or less.

### 4. Water (D)

Water (D) is mixed into the mixed composition (p). An amount of water (D) is preferably 2% by mass or less, with the total amount of the mixed composition (p) taken as 100% by mass, providing the following advantages thereby: reaction during formation of a coating film can be caused to mildly proceed and a superior coating film can be formed. The amount of water (D) is preferably 1.5% by mass or less and more preferably 1.0% by mass or less and preferably 0.005% by mass or more, more preferably 0.01% by mass or more, and still more preferably 0.015% by mass or more.

The amount of water (D) based on the total of the organic silicon compound (A) and organic silicon compound (B) as 100% by mass (water (D)/{organic silicon compound (A)+organic silicon compound (B)}) is preferably 40% by mass or more, more preferably 60% by mass or more, and still more preferably 90% by mass or more and preferably 300% by mass or less and more preferably 250% by mass or less.

### 5. Solvent (E)

The solvent (E) means a solvent other than water, and examples thereof include an alcohol-based solvent, an ether-based solvent, a ketone-based solvent, an ester-based solvent, an amide-based solvent, etc.

Examples of the alcohol-based solvent include methanol, ethanol, propanol, 2-propanol (isopropyl alcohol), butanol, ethylene glycol, propylene glycol, diethylene glycol, etc.

Examples of the ether-based solvent include dimethoxyethane, tetrahydrofuran, dioxane, etc.

Examples of the ketone-based solvent include acetone, methyl ethyl ketone (2-butanone), etc.

Examples of the ester-based solvent include ethyl acetate, butyl acetate, etc.

Examples of the amide-based solvent include dimethyl formamide, etc. Among them, an alcohol-based solvent or ether-based solvent is preferable, and an alcohol-based solvent is more preferable.

An amount of the solvent (E) is preferably 10% by mass or more, more preferably 50% by mass or more, still more preferably 90% by mass or more, and especially preferably 95% by mass or more and preferably 99.95% by mass or less, more preferably 99.90% by mass or less, and still more preferably 99.80% by mass or less, with the total amount of the mixed composition (p) taken as 100% by mass.

Various additives such as an antioxidant, an antirust agent, an ultraviolet absorber, a photostabilizer, a fungicide, an antibacterial agent, an anti-biofouling agent, a deodorant, a pigment, a flame retardant, and an antistatic agent, for example, are optionally allowed to coexist in the mixed composition (p) within a range not inhibiting the effect of the present invention.

A mixing order of the components used for the mixed composition (p) is not particularly limited, and it is preferable that all components are added, followed by stirring at about 20° C. to 80° C. (preferably, 40° C. to 80° C.) for one to six hours. The layer (M) and layer (K1) cured from the mixed composition (p) are formed, and the layer (M) serves as a liquid-repellent layer and is excellent in water repellency and oil repellency. In addition, the coating film of the present invention having the layer (M) and the layer (K1) is excellent in wear resistance.

Next, the mixed composition (q) will be described. A polysilazane (F) is used for the mixed composition (q), and usually a solvent (I) is also used for the mixed composition (q). In addition, at least one kind of a metal compound (G) and a siloxane chain-including compound (H) is optionally used for the mixed composition (q) in addition to the polysilazane (F) if needed.

### 6. Polysilazane (F)

While the polysilazane (F) is not particularly limited as long as it is a compound having a silicon-nitrogen bond, the polysilazane (F) preferably has a structural unit represented by formula (f1) below.

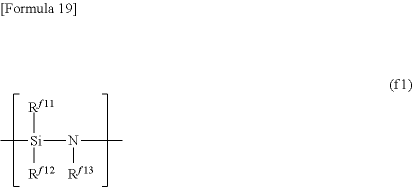

[In formula (f1), R^{f11}, R^{f12}, and R^{f13} each independently represent a hydrogen atom, a hydrocarbon group having 1 to 10 carbon atoms and optionally having a substituent, or an alkylsilyl group.]

Examples of the hydrocarbon group having 1 to 10 carbon atoms represented by R^{f11} to R^{f13} include a linear saturated aliphatic hydrocarbon group such as a methyl group, an ethyl group, a propyl group, a butyl group, a pentyl group, a hexyl group, a heptyl group, an octyl group, a nonyl group, and a decyl group; a branched saturated aliphatic hydrocarbon group such as an isopropyl group, a sec-butyl group, a tert-butyl group, a methylpentyl group, an ethylpentyl group, a methylhexyl group, an ethylhexyl group, a propylhexyl group, and a tert-octyl group; a cyclic saturated aliphatic hydrocarbon group such as a cyclopentyl group, cyclohexyl group, a cycloheptyl group, and a cyclooctyl group; an unsaturated aliphatic hydrocarbon group such as a vinyl group, a 1-propenyl group, a 2-propenyl group, a 1-butenyl group, a 2-butenyl group, and a 3-butenyl group; an aromatic hydrocarbon group such as a phenyl group, a naphthyl group, a p-tert-butylphenyl group, a tolyl group, a xylyl group, a cumenyl group, a mesityl group, a 2,6-diethylphenyl group, and a 2-methyl-6-ethylphenyl group; and a group in which the above-listed hydrocarbon groups are combined such as an alkylcycloalkyl group, a cycloalkylalkyl group, and an aralkyl group.

Examples of the substituent that the hydrocarbon group having 1 to 10 carbon atoms optionally has include a halogen atom selected from a fluorine atom, a chlorine atom, a bromine atom, and an iodine atom; a hydroxy group; a nitro group; an amino group; a cyano group; a thiol group; an epoxy group; a glycidoxy group; a (meth)acloyloxy group; a heteroaryl group with 6 to 12 atoms forming the ring thereof; an alkoxy group having 1 to 3 carbon atoms such as a methoxy group and an ethoxy group; an aryloxy group with 6 to 12 carbon atoms forming the ring thereof; etc.

The hydrocarbon group having 1 to 10 carbon atoms represented by R^{f11} to R^{f13} is preferably an unsubstituted saturated aliphatic hydrocarbon group having 1 to 10 carbon atoms, more preferably an unsubstituted saturated linear aliphatic hydrocarbon group having 1 to 6 carbon atoms, still more preferably an unsubstituted methyl group, ethyl group, propyl group, or butyl group, and most preferably a methyl group.

Examples of the alkylsilyl group represented by R^{f11} to R^{f13} include a trimethylsilyl group, a triethylsilyl group, a tri-n-propylsilyl group, a triisopropylsilyl group, a tri-t-butylsilyl group, a methyldiethylsilyl group, a dimethylsilyl group, a diethylsilyl group, a methylsilyl group, an ethylsilyl group, etc.

The polysilazane (F) is preferably a polysilazane having structural unit (f2) in which, at least one of R^{f11} and R^{f12} in formula (f1) above is a hydrocarbon group having 1 to 10 carbon atoms, that is, an organic polysilazane. In addition, R^{f13} is preferably a hydrogen atom.

It is more preferable that the polysilazane (F) further has a structural unit represented by formula (f3) below in addition to structural unit (f2) described above.

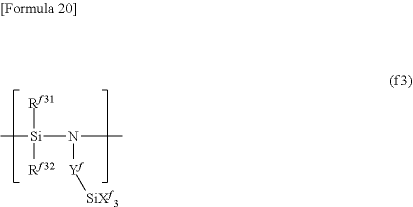

[In formula (f3), R^{f31} and R^{f32} each independently represent a hydrogen atom or a hydrocarbon group having 1 to 10 carbon atoms; Y^{f} represents a divalent hydrocarbon group having 1 to 10 carbon atoms; and multiple X^{f}s each independently represent a hydrolyzable group.]

The hydrocarbon group having 1 to 10 carbon atoms represented by R^{f31} and R^{f32} includes the same groups described for the hydrocarbon group having 1 to 10 carbon atoms represented by R^{f11} to R^{f13}. Among them, a saturated aliphatic hydrocarbon group having 1 to 10 carbon atoms is preferable, a saturated linear aliphatic hydrocarbon group having 1 to 6 carbon atoms is more preferable, and a methyl group, an ethyl group, a propyl group, or a butyl group is still more preferable.

The number of carbon atoms of the divalent hydrocarbon group represented by Y^{f} is preferably 1 to 4, more preferably 1 to 3, and still more preferably 1 to 2. The divalent hydrocarbon group is preferably chained, and when the divalent hydrocarbon group is chained, the divalent hydrocarbon group may be linear or branched. In addition, the divalent hydrocarbon group is preferably a divalent aliphatic hydrocarbon group and preferably an alkanediyl group. Examples of the divalent hydrocarbon group include a methylene group, an ethylene group, a propylene group, a butylene group, etc.

Furthermore, a part of —CH₂— moieties included in the divalent hydrocarbon group is optionally replaced by —O—. In this case, successive two —CH₂— moieties are not simultaneously replaced by —O—, and —CH₂— adjacent to a Si atom is not replaced by —O—. When two or more —CH₂-moieties are replaced by —O—, the number of carbon atoms between —O— and —O— is preferably 2 to 4 and more preferably 2 to 3. Specific examples of a group in which a part of the divalent hydrocarbon group is replaced by —O— can be a group having a (poly)ethylene glycol unit, a group having a (poly)propylene glycol unit, and the like.

The hydrolyzable group of X^{f} may be a group providing a hydroxy group (silanol group) through hydrolysis, and preferable examples thereof can include an alkoxy group having 1 to 4 carbon atoms such as a methoxy group, an ethoxy group, a propoxy group, and a butoxy group; a hydroxy group; an acetoxy group; a chlorine atom; an isocyanate group; etc. Among them, an alkoxy group having 1 to 4 carbon atoms is preferable, and an alkoxy group having 1 to 2 carbon atoms is more preferable. Multiple X^{f}s may be the same or different and preferably the same.

The SiX^{f}₃ group of formula (f3) is preferably contained in an amount of 2% by mass or more, more preferably 5% by mass or more, and still more preferably 8% by mass or more, based on 100% by mass of the polysilazane (F). The upper limit thereof is not limited but may be 50% by mass or less, may be 40% by mass or less, and may be 30% by mass or less.

When the polysilazane (F) is an organic polysilazane, a content ratio between the hydrogen atom in Si—H and the hydrocarbon group having 1 to 10 carbon atoms bonded to Si can be appropriately selected. However, a mole ratio of hydrocarbon group/hydrogen atom is 0.1 to 50 and preferably 0.2 to 10, for example. Incidentally, the mole ratio thereof can be calculated by NMR measurement or the like.

An amount of the polysilazane (F) is preferably 0.01% by mass or more, more preferably 0.05% by mass or more, still more preferably 0.1% by mass or more, and further preferably 0.3% by mass or more and preferably 2.5% by mass or less, more preferably 2% by mass or less, still more preferably 1.5% by mass or less, and further preferably 1% by mass or less, with the total amount of the mixed composition (q) taken as 100% by mass.

### 7. Metal Compound (G)

At least one of a metal compound (G) represented by formula (g1) below and a condensate thereof (preferably, the metal compound (G) and a condensate thereof) is optionally mixed into the mixed composition (q).

M(R^{g10})ᵣ(A^{g1})ₘ₋ᵣ (g1)

[In formula (g1), M represents Al, Fe, In, Ge, Hf, Si, Ti, Sn, Zr, or Ta; R91⁰ represents a hydrocarbon chain-containing group or a hydrogen atom; and r is 0 or 1. Multiple A^{g1}s each independently represent a hydrolyzable group, and m is a valence of the metal atom M and an integer selected from 3 to 5.]

As represented by formula (g1) above, the metal compound (G) is a compound in which at least the hydrolyzable groups A91 are bonded to the metal atom M. Incidentally, the term “metal” in the present specification is used to mean to include metalloids such as Si and Ge.

The metal atom M is preferably Al, Si, Ti, Sn, or Zr, more preferably Al, Si, Ti, or Zr, and still more preferably Si.

The hydrolyzable group represented by A^{g1} and the hydrocarbon chain-containing group represented by R^{g10} can be appropriately selected from the hydrolyzable groups and hydrocarbon chain-containing groups described for the organic silicon compound (A), and preferable ranges thereof are also the same.

The symbol m is three when the metal atom M is a trivalent metal such as Al, Fe, and In, four when the metal atom M is a tetravalent metal such as Ge, Hf, Si, Ti, Sn, and Zr, and five when the metal atom M is a pentavalent metal such as Ta.

Two or more kinds of the metal compound (G) may be used.

The metal compound (G) includes a metal compound G1 in which r=0, that is, only hydrolyzable groups A91 are bonded to the metal atom M thereof; or a metal compound G2 in which r=1, that is, one hydrocarbon chain-containing group or hydrogen atom and two or more hydrolyzable groups A91 are bonded to the metal atom M thereof.

### (Metal Compound G1)

Specifically, examples of the metal compound G1 in which only hydrolyzable groups A^{g1} are bonded to the metal atom M thereof include a trialkoxyaluminum such as triethoxyaluminum, tripropoxyaluminum, and tributoxyaluminum; a trialkoxyiron such as triethoxyiron; a trialkoxyindium such as trimethoxyindium, triethoxyindium, tripropoxyindium, and tributoxyindium; a tetraalkoxygermanium such as tetramethoxygermanium, tetraethoxygermanium, tetrapropoxygermanium, and tetrabutoxygermanium; a tetraalkoxyhafnium such as tetramethoxyhafnium, tetraethoxyhafnium, tetrapropoxyhafnium, and tetrabutoxyhafnium; a tetraalkoxysilane such as tetramethoxysilane, tetraethoxysilane, tetrapropoxysilane, and tetrabutoxysilane; a tetraalkoxytitanium such as tetramethoxytitanium, tetraethoxytitanium, tetrapropoxytitanium, and tetrabutoxytitanium; a tetraalkoxytin such as tetramethoxytin, tetraethoxytin, tetrapropoxytin, and tetrabutoxytin; a tetraalkoxyzirconium such as tetramethoxyzirconium, tetraethoxyzirconium, tetrapropoxyzirconium, and tetrabutoxyzirconium; a pentaalkoxytantalum such as pentamethoxytantalum, pentaethoxytantalum, pentapropoxytantalum, and pentabutoxytantalum; etc.

### (Metal Compound G2)

In the metal compound G2 in which one hydrocarbon chain-containing group or hydrogen atom and two or more hydrolyzable groups A^{g1} are bonded to the metal atom M thereof, the metal atom M is preferably a tetravalent metal (Ge, Hf, Si, Ti, Sn, Zr, etc.), and when the metal atom M is Si, specific examples thereof include an alkyltrialkoxysilane such as methyltrimethoxysilane, ethyltrimethoxysilane, methyltriethoxysilane, ethyltriethoxysilane, and methyltripropoxysilane; an alkenyltrialkoxysilane such as vinyltrimethoxysilane and vinyltriethoxysilane; a trialkoxysilane such as trimethoxysilane, triethoxysilane, and tripropoxysilane; a dialkoxyalkylsilane such as dimethoxymethylsilane and diethoxymethylsilane; etc.

Specifically, the metal compound (G) is preferably a compound represented by formula (g2) below.

Si(OR^{g21})_{y}H_{4-y} (g2)

[In formula (g2), R^{g21} represents an alkyl group having 1 to 6 carbon atoms, and y is 3 or 4.]

Examples of the alkyl group represented by R^{g21} include a methyl group, an ethyl group, a propyl group, a butyl group, a pentyl group, a hexyl group, etc. The number of carbon atoms of the alkyl group represented by R^{g21} is preferably 1 to 4, more preferably 1 to 3, and still more preferably 1 or 2.

An amount of the metal compound (G) is preferably 0.01% by mass or more, more preferably 0.05% by mass or more, still more preferably 0.1% by mass or more, and especially preferably 0.15% by mass or more and preferably 10% by mass or less, more preferably 3% by mass or less, still more preferably 1% by mass or less, and especially preferably 0.8% by mass or less, with the total amount of the mixed composition (q) taken as 100% by mass, for example.

A total amount of the polysilazane (F) and the metal compound (G) is preferably 0.02% by mass or more and more preferably 0.1% by mass or more and preferably 10% by mass or less, more preferably 5% by mass or less, still more preferably 3% by mass or less, and especially preferably 1% by mass or less, with the total amount of the mixed composition (q) taken as 100% by mass, for example.

### 8. Siloxane Chain-Including Compound (H)

The siloxane chain-including compound (H) is not particularly limited as long as it is a compound having at least one siloxane bond. The siloxane chain may be linear or branched but is preferably linear.

The siloxane chain preferably includes a dialkylsiloxane chain and more preferably includes a linear dialkylsiloxane chain. The siloxane chain optionally includes an additional divalent group other than a siloxane bond, and the divalent group includes a divalent hydrocarbon group, a group in which a part of methylene groups (—CH₂—) of a divalent hydrocarbon is replaced by an oxygen atom, —O—, etc.

It is preferable that a silyl group is bonded to a terminal of the siloxane chain. A silyl group is a group in which three substituents are bonded to a silicon atom, and examples of the substituent include a hydrogen atom, a hydrocarbon chain-containing group, an alkylsilyloxy group, a group including an alkylsilyl group and a siloxane chain, a hydrolyzable group, etc.

The hydrocarbon chain-containing group usually consists only of a hydrocarbon group (hydrocarbon chain) but may be a group in which a part of methylene groups (—CH₂—) of this hydrocarbon chain is replaced by an oxygen atom if needed. In addition, a methylene group (—CH₂—) adjacent to a Si atom is not replaced by an oxygen atom, and successive two methylene groups (—CH₂—) are not simultaneously replaced by oxygen atoms.

Incidentally, the number of carbon atoms in a hydrocarbon chain moiety means the number of carbon atoms constituting the hydrocarbon group (hydrocarbon chain) for a hydrocarbon chain-containing group unsubstituted with oxygen and means the number of carbon atoms counted on the assumption that an oxygen atom is a methylene group (—CH₂—) for an oxygen-substituted hydrocarbon chain-containing group.

Hereinafter, unless otherwise stated, the hydrocarbon chain-containing group will be described by way of a hydrocarbon chain-containing group unsubstituted with oxygen (that is, a monovalent hydrocarbon group) as an example; however, a part of methylene groups (—CH₂—) thereof can be replaced by an oxygen atom in any description.

When the hydrocarbon chain-containing group is a hydrocarbon group, the number of carbon atoms thereof is preferably one or more and three or less and more preferably one. In addition, the hydrocarbon chain-containing group may be branched or linear. The hydrocarbon chain-containing group is preferably a saturated or unsaturated aliphatic hydrocarbon chain-containing group and more preferably a saturated aliphatic hydrocarbon chain-containing group. The saturated aliphatic hydrocarbon chain-containing group is more preferably a saturated aliphatic hydrocarbon group (an alkyl group). Examples of the saturated aliphatic hydrocarbon group include a methyl group, an ethyl group, a propyl group, etc.

When a part of methylene groups (—CH₂—) of the saturated aliphatic hydrocarbon group is replaced by an oxygen atom, a group having a (poly)ethylene glycol unit, or the like can be specifically exemplified.

The hydrolyzable group may be a group providing a hydroxy group (silanol group) through hydrolysis, and preferable examples thereof can include an alkoxy group having 1 to 6 carbon atoms such as a methoxy group, an ethoxy group, a propoxy group, and a butoxy group; a hydroxy group; an acetoxy group; a chlorine atom; an isocyanate group; etc. Among them, an alkoxy group having 1 to 6 carbon atoms is preferable, an alkoxy group having 1 to 4 carbon atoms is more preferable, and an alkoxy group having 1 to 2 carbon atoms is further preferable.

When one silicon atom in a silyl group bonded to a terminal of the siloxane chain has multiple substituents, the multiple substituents may be the same of different.

It is preferable that a silicon atom to which at least one hydrolyzable group is bonded is bonded, more preferably a silicon atom to which two or more hydrolyzable groups are bonded is bonded, and still more preferably a silicon atom to which three hydrolyzable groups are bonded is bonded to at least one terminal of the siloxane chain. While a silicon atom to which the hydrolyzable group is bonded may be bonded to both terminals of the siloxane chain, it is preferable that a silicon atom to which the hydrolyzable group is bonded is bonded to only one terminal of the siloxane chain.

It is more preferable that any of a silyl group having three alkoxy groups as substituents (trialkoxysilyl group), a silyl group having three alkyl groups as substituents (trialkylsilyl group), and a silyl group having three trialkylsilyloxy groups as substituents (tris(trialkylsilyloxy)silyl group) is bonded to the both terminals of the siloxane chain, and it is especially preferable that a trialkoxysilyl group is bonded to one terminal and a trialkylsilyl group or tris(trialkylsilyloxy)silyl group is bonded to the other terminal.

In a more preferable aspect, the siloxane chain-including compound (H) is a compound in which a molecular chain having a trialkylsilyl group and a siloxyane chain (hereinafter, this molecular chain is sometimes referred to as the “molecular chain (ts1)”) is bonded to at least one silicon atom (hereinafter, this silicone atom is sometimes referred to as the “central silicon atom”).

In the siloxane chain-including compound (H), the number of molecular chains (ts1) bonded to the central silicon atom is preferably one or more and three or less, more preferably two or less, and especially preferably one.

A hydrolyzable group, a siloxane skeleton-containing group with the number of atoms less than the number of atoms constituting the molecular chain (ts1), or a hydrocarbon chain-containing group containing a hydrocarbon chain with the number of carbon atoms less than the number of atoms constituting the molecular chain (ts1) is optionally bonded to the central silicon atom of the siloxane chain-including compound (H) in addition to the molecular chain (ts1).

Specifically, the siloxane chain-including compound (H) is preferably a compound represented by formula (h1) below.

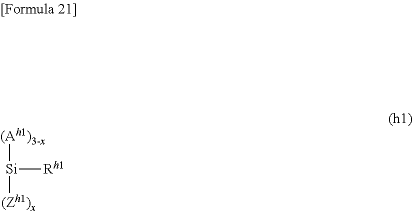

[In formula (h1), R^{h1} represents a molecular chain having a trialkylsilyl group and a siloxane chain; A^{h1}s each independently represent a hydrolyzable group; Z^{h1} represents a molecular chain having a trialkylsilyl group and a siloxane chain, a siloxane skeleton-containing group, or a hydrocarbon chain-containing group; a hydrogen atom included in the trialkylsilyl group of R^{h1} and Z^{h1} is optionally substituted with a fluorine atom; and x represents an integer of 0 to 3.]

The molecular chain having a trialkylsilyl group and a siloxane chain (molecular chain (ts1)) of R^{h1} is a monovalent group having a structure in which a trialkylsilyl-containing group is bonded to a terminal of the siloxane chain. An alkyl group of the trialkylsilyl-containing group is optionally replaced by a fluoroalkyl group.

The trialkylsilyl-containing group is a group including at least one trialkylsilyl group and preferably has two or more, more preferably three trialkylsilyl groups.

The trialkylsilyl-containing group is preferably a group represented by formula (s1) above as with the organic silicon compound (A).

In the molecular chain (ts1), the trialkylsilyl-containing group is preferably bonded to a terminal (free end side) of the siloxane chain, especially, to a terminal (free end side) of the main chain (longest linear chain) of the siloxane chain.

The siloxane chain to which the trialkylsilyl-containing group is bonded is the same as the siloxane chain described above and preferably includes a linear dialkylsiloxane chain. In addition, the molecular chain optionally includes a divalent hydrocarbon group. Even when a part of the molecular chain is a divalent hydrocarbon group, the obtained coating film has good chemical and physical durability because the residual part is a dialkylsiloxane chain.

The siloxane chain is preferably a group represented by formula (s2) above shown for the organic silicon compound (A1).

In addition, the total number of atoms constituting the molecular chain (ts1) is preferably 24 or more, more preferably 40 or more, and still more preferably 50 or more, and an upper limit of a preferable range is preferably 5000 or less, 4000 or less, 2000 or less, 1200 or less, 700 or less, and 250 or less in turn.

Next, A^{h1} in formula (h1) will be described. A^{h1}s are each independently a hydrolyzable group and may be a group providing a hydroxy group (silanol group) through hydrolysis, and preferable examples thereof can include an alkoxy group having 1 to 6 carbon atoms such as a methoxy group, an ethoxy group, a propoxy group, and a butoxy group; a hydroxy group; an acetoxy group; a chlorine atom; an isocyanate group; etc. Among them, an alkoxy group having 1 to 6 carbon atoms is preferable, an alkoxy group having 1 to 4 carbon atoms is more preferable, and an alkoxy group having 1 to 2 carbon atoms is still more preferable.

Z^{h1} in formula (h1) represents a molecular chain having a trialkylsilyl group and a siloxane chain, a siloxane skeleton-containing group, or a hydrocarbon chain-containing group. When Z^{h1} is a molecular chain having a trialkylsilyl group and a siloxane chain, those same as in R^{h1} above are exemplified.

When Z^{h1} is a siloxane skeleton-containing group, the siloxane skeleton-containing group is a monovalent group containing a siloxane unit (Si—O—) and preferably consists of atoms with the number thereof being less than the number of atoms constituting the molecular chain (ts1) of R^{h1}. Hence, the siloxane skeleton-containing group becomes a group which has a length shorter than the molecular chain (ts1) or which is sterically less spread (less bulky). The siloxane skeleton-containing group optionally includes a divalent hydrocarbon group.

The siloxane skeleton-containing group is preferably a group represented by formula (s4) shown above for the organic silicon compound (A).

The total number of atoms of the siloxane skeleton-containing group is preferably 600 or less, more preferably 500 or less, still more preferably 350 or less, further preferably 100 or less, still further preferably 50 or less, and especially preferably 30 or less and preferably 10 or more. In addition, a difference in the number of atoms between the molecular chain (ts1) of R^{h1} and the siloxane skeleton-containing group of Z^{h1} is preferably 10 or more and more preferably 20 or more and preferably 1000 or less, more preferably 500 or less, and still more preferably 200 or less.

When Z^{h1} is a hydrocarbon chain-containing group, the hydrocarbon chain-containing group may be a group with the number of carbon atoms of its hydrocarbon chain moiety being less than the number of atoms constituting the molecular chain (ts1). In addition, it is preferable that the hydrocarbon chain-containing group is a group with the number of carbon atoms of the longest linear chain of its hydrocarbon chain being less than the number of atoms constituting the longest linear chain of the molecular chain (ts1). The same groups as in the hydrocarbon chain-containing group exemplified above can be exemplified as the hydrocarbon chain-containing group.

The symbol x in formula (h1) is preferably an integer of 2 or less, more preferably 0 or 1, and still more preferably 0.

Specifically, the siloxane chain-including compound (H) represented by formula (h1) includes a compound represented by formula (h-I). In formula (h-I), A^{h10}, Z^{h10}, R^{h20}, h10, Y^{h10}, and R^{h10} are preferably combinations shown in the following Tables 5-1, 5-2, 6-1, and 6-2.

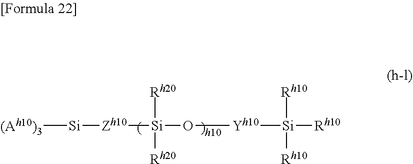

TABLE 5-1

| | A^{h10} | Z^{h10} | R^{h10} | h10 | Y^{h10} | R^{h10} |
|---|---|---|---|---|---|---|
| (h-I-1) | C₂H₅O—* | *—O—* | CH₃—* | 1~60 | — | (CH₃)₃SiO—* |
| (h-I-2) | C₂H₅O—* | *—O—* | CH₃—* | 1~60 | *—Si(CH₃)₂—CH₂—* | (CH₃)₃SiO—* |
| (h-I-3) | C₂H₅O—* | *—O—* | CH₃—* | 1~60 | *—Si(CH₃)₂—(CH₂)₂—* | (CH₃)₃SiO—* |
| (h-I-4) | C₂H₅O—* | *—O—* | CH₃—* | 1~60 | *—Si(CH₃)₂—(CH₂)₃—* | (CH₃)₃SiO—* |
| (h-I-5) | C₂H₅O—* | *—O—* | CH₃—* | 1~60 | *—Si(CH₃)₂—(CH₂)₄—* | (CH₃)₃SiO—* |
| (h-I-6) | C₂H₅O—* | *—CH₂—* | CH₃—* | 1~60 | — | (CH₃)₃SiO—* |
| (h-I-7) | C₂H₅O—* | *—CH₂—* | CH₃—* | 1~60 | *—Si(CH₃)₂—CH₂—* | (CH₃)₃SiO—* |
| (h-I-8) | C₂H₅O—* | *—CH₂—* | CH₃—* | 1~60 | *—Si(CH₃)₂—(CH₂)₂—* | (CH₃)₃SiO—* |
| (h-I-9) | C₂H₅O—* | *—CH₂—* | CH₃—* | 1~60 | *—Si(CH₃)₂—(CH₂)₃—* | (CH₃)₃SiO—* |
| (h-I-10) | C₂H₅O—* | *—CH₂—* | CH₃—* | 1~60 | *—Si(CH₃)₂—(CH₂)₄—* | (CH₃)₃SiO—* |
| (h-I-11) | C₂H₅O—* | *—(CH₂)₂—* | CH₃—* | 1~60 | — | (CH₃)₃SiO—* |
| (h-I-12) | C₂H₅O—* | *—(CH₂)₂—* | CH₃—* | 1~60 | *—Si(CH₃)₂—CH₂—* | (CH₃)₃SiO—* |
| (h-I-13) | C₂H₅O—* | *—(CH₂)₂—* | CH₃—* | 1~60 | *—Si(CH₃)₂—(CH₂)₂—* | (CH₃)₃SiO—* |
| (h-I-14) | C₂H₅O—* | *—(CH₂)₂—* | CH₃—* | 1~60 | *—Si(CH₃)₂—(CH₂)₃—* | (CH₃)₃SiO—* |
| (h-I-15) | C₂H₅O—* | *—(CH₂)₂—* | CH₃—* | 1~60 | *—Si(CH₃)₂—(CH₂)₄—* | (CH₃)₃SiO—* |
| (h-I-16) | C₂H₅O—* | *—(CH₂)₃—* | CH₃—* | 1~60 | — | (CH₃)₃SiO—* |
| (h-I-17) | C₂H₅O—* | *—(CH₂)₃—* | CH₃—* | 1~60 | *—Si(CH₃)₂—CH₂—* | (CH₃)₃SiO—* |
| (h-I-18) | C₂H₅O—* | *—(CH₂)₃—* | CH₃—* | 1~60 | *—Si(CH₃)₂—(CH₂)₂—* | (CH₃)₃SiO—* |
| (h-I-19) | C₂H₅O—* | *—(CH₂)₃—* | CH₃—* | 1~60 | *—Si(CH₃)₂—(CH₂)₃—* | (CH₃)₃SiO—* |
| (h-I-20) | C₂H₅O—* | *—(CH₂)₃—* | CH₃—* | 1~60 | *—Si(CH₃)₂—(CH₂)₄—* | (CH₃)₃SiO—* |
| (h-I-21) | C₂H₅O—* | *—(CH₂)₄—* | CH₃—* | 1~60 | — | (CH₃)₃SiO—* |
| (h-I-22) | C₂H₅O—* | *—(CH₂)₄—* | CH₃—* | 1~60 | *—Si(CH₃)₂—CH₂—* | (CH₃)₃SiO—* |
| (h-I-23) | C₂H₅O—* | *—(CH₂)₄—* | CH₃—* | 1~60 | *—Si(CH₃)₂—(CH₂)₂—* | (CH₃)₃SiO—* |
| (h-I-24) | C₂H₅O—* | *—(CH₂)₄—* | CH₃—* | 1~60 | *—Si(CH₃)₂—(CH₂)₃—* | (CH₃)₃SiO—* |
| (h-I-25) | C₂H₅O—* | *—(CH₂)₄—* | CH₃—* | 1~60 | *—Si(CH₃)₂—(CH₂)₄—* | (CH₃)₃SiO—* |

TABLE 5-2

| | A^{h10} | Z^{h10} | R^{h10} | h10 | Y^{h10} | R^{h10} |
|---|---|---|---|---|---|---|
| (h-I-26) | CH₃O—* | *—O—* | CH₃—* | 1~60 | — | (CH₃)₃SiO—* |
| (h-I-27) | CH₃O—* | *—O—* | CH₃—* | 1~60 | *—Si(CH₃)₂—CH₂—* | (CH₃)₃SiO—* |
| (h-I-28) | CH₃O—* | *—O—* | CH₃—* | 1~60 | *—Si(CH₃)₂—(CH₂)₂—* | (CH₃)₃SiO—* |
| (h-I-29) | CH₃O—* | *—O—* | CH₃—* | 1~60 | *—Si(CH₃)₂—(CH₂)₃—* | (CH₃)₃SiO—* |
| (h-I-30) | CH₃O—* | *—O—* | CH₃—* | 1~60 | *—Si(CH₃)₂—(CH₂)₄—* | (CH₃)₃SiO—* |
| (h-I-31) | CH₃O—* | *—CH₂—* | CH₃—* | 1~60 | — | (CH₃)₃SiO—* |
| (h-I-32) | CH₃O—* | *—CH₂—* | CH₃—* | 1~60 | *—Si(CH₃)₂—CH₂—* | (CH₃)₃SiO—* |
| (h-I-33) | CH₃O—* | *—CH₂—* | CH₃—* | 1~60 | *—Si(CH₃)₂—(CH₂)₂—* | (CH₃)₃SiO—* |
| (h-I-34) | CH₃O—* | *—CH₂—* | CH₃—* | 1~60 | *—Si(CH₃)₂—(CH₂)₃—* | (CH₃)₃SiO—* |
| (h-I-35) | CH₃O—* | *—CH₂—* | CH₃—* | 1~60 | *—Si(CH₃)₂—(CH₂)₄—* | (CH₃)₃SiO—* |
| (h-I-36) | CH₃O—* | *—(CH₂)₂—* | CH₃—* | 1~60 | — | (CH₃)₃SiO—* |
| (h-I-37) | CH₃O—* | *—(CH₂)₂—* | CH₃—* | 1~60 | *—Si(CH₃)₂—CH₂—* | (CH₃)₃SiO—* |
| (h-I-38) | CH₃O—* | *—(CH₂)₂—* | CH₃—* | 1~60 | *—Si(CH₃)₂—(CH₂)₂—* | (CH₃)₃SiO—* |
| (h-I-38) | CH₃O—* | *—(CH₂)₂—* | CH₃—* | 1~60 | *—Si(CH₃)₂—(CH₂)₃—* | (CH₃)₃SiO—* |
| (h-I-40) | CH₃O—* | *—(CH₂)₂—* | CH₃—* | 1~60 | *—Si(CH₃)₂—(CH₂)₄—* | (CH₃)₃SiO—* |
| (h-I-41) | CH₃O—* | *—(CH₂)₃—* | CH₃—* | 1~60 | — | (CH₃)₃SiO—* |
| (h-I-42) | CH₃O—* | *—(CH₂)₃—* | CH₃—* | 1~60 | *—Si(CH₃)₂—CH₂—* | (CH₃)₃SiO—* |
| (h-I-43) | CH₃O—* | *—(CH₂)₃—* | CH₃—* | 1~60 | *—Si(CH₃)₂—(CH₂)₂—* | (CH₃)₃SiO—* |
| (h-I-44) | CH₃O—* | *—(CH₂)₃—* | CH₃—* | 1~60 | *—Si(CH₃)₂—(CH₂)₃—* | (CH₃)₃SiO—* |
| (h-I-45) | CH₃O—* | *—(CH₂)₃—* | CH₃—* | 1~60 | *—Si(CH₃)₂—(CH₂)₄—* | (CH₃)₃SiO—* |
| (h-I-46) | CH₃O—* | *—(CH₂)₄—* | CH₃—* | 1~60 | — | (CH₃)₃SiO—* |
| (h-I-47) | CH₃O—* | *—(CH₂)₄—* | CH₃—* | 1~60 | *—Si(CH₃)₂—CH₂—* | (CH₃)₃SiO—* |
| (h-I-48) | CH₃O—* | *—(CH₂)₄—* | CH₃—* | 1~60 | *—Si(CH₃)₂—(CH₂)₂—* | (CH₃)₃SiO—* |
| (h-I-49) | CH₃O—* | *—(CH₂)₄—* | CH₃—* | 1~60 | *—Si(CH₃)₂—(CH₂)₃—* | (CH₃)₃SiO—* |
| (h-I-50) | CH₃O—* | *—(CH₂)₄—* | CH₃—* | 1~60 | *—Si(CH₃)₂—(CH₂)₄—* | (CH₃)₃SiO—* |

TABLE 6-1

| | A^{h10} | Z^{h10} | R^{h10} | h10 | Y^{h10} | R^{h10} |
|---|---|---|---|---|---|---|
| (h-I-51) | C₂H₅O—* | *—O—* | CH₃—* | 1~60 | — | CH₃—* |
| (h-I-52) | C₂H₅O—* | *—O—* | CH₃—* | 1~60 | *—Si(CH₃)₂—CH₂—* | CH₃—* |
| (h-I-53) | C₂H₅O—* | *—O—* | CH₃—* | 1~60 | *—Si(CH₃)₂—(CH₂)₂—* | CH₃—* |
| (h-I-54) | C₂H₅O—* | *—O—* | CH₃—* | 1~60 | *—Si(CH₃)₂—(CH₂)₃—* | CH₃—* |
| (h-I-55) | C₂H₅O—* | *—O—* | CH₃—* | 1~60 | *—Si(CH₃)₂—(CH₂)₄—* | CH₃—* |
| (h-I-56) | C₂H₅O—* | *—CH₂—* | CH₃—* | 1~60 | — | CH₃—* |
| (h-I-57) | C₂H₅O—* | *—CH₂—* | CH₃—* | 1~60 | *—Si(CH₃)₂—CH₂—* | CH₃—* |
| (h-I-58) | C₂H₅O—* | *—CH₂—* | CH₃—* | 1~60 | *—Si(CH₃)₂—(CH₂)₂—* | CH₃—* |
| (h-I-59) | C₂H₅O—* | *—CH₂—* | CH₃—* | 1~60 | *—Si(CH₃)₂—(CH₂)₃—* | CH₃—* |
| (h-I-60) | C₂H₅O—* | *—CH₂—* | CH₃—* | 1~60 | *—Si(CH₃)₂—(CH₂)₄—* | CH₃—* |
| (h-I-61) | C₂H₅O—* | *—(CH₂)₂—* | CH₃—* | 1~60 | — | CH₃—* |
| (h-I-62) | C₂H₅O—* | *—(CH₂)₂—* | CH₃—* | 1~60 | *—Si(CH₃)₂—CH₂—* | CH₃—* |
| (h-I-63) | C₂H₅O—* | *—(CH₂)₂—* | CH₃—* | 1~60 | *—Si(CH₃)₂—(CH₂)₂—* | CH₃—* |
| (h-I-64) | C₂H₅O—* | *—(CH₂)₂—* | CH₃—* | 1~60 | *—Si(CH₃)₂—(CH₂)₃—* | CH₃—* |
| (h-I-65) | C₂H₅O—* | *—(CH₂)₂—* | CH₃—* | 1~60 | *—Si(CH₃)₂—(CH₂)₄—* | CH₃—* |
| (h-I-66) | C₂H₅O—* | *—(CH₂)₃—* | CH₃—* | 1~60 | — | CH₃—* |
| (h-I-67) | C₂H₅O—* | *—(CH₂)₃—* | CH₃—* | 1~60 | *—Si(CH₃)₂—CH₂—* | CH₃—* |
| (h-I-68) | C₂H₅O—* | *—(CH₂)₃—* | CH₃—* | 1~60 | *—Si(CH₃)₂—(CH₂)₂—* | CH₃—* |
| (h-I-69) | C₂H₅O—* | *—(CH₂)₃—* | CH₃—* | 1~60 | *—Si(CH₃)₂—(CH₂)₃—* | CH₃—* |
| (h-I-70) | C₂H₅O—* | *—(CH₂)₃—* | CH₃—* | 1~60 | *—Si(CH₃)₂—(CH₂)₄—* | CH₃—* |
| (h-I-71) | C₂H₅O—* | *—(CH₂)₄—* | CH₃—* | 1~60 | — | CH₃—* |
| (h-I-72) | C₂H₅O—* | *—(CH₂)₄—* | CH₃—* | 1~60 | *—Si(CH₃)₂—CH₂—* | CH₃—* |
| (h-I-73) | C₂H₅O—* | *—(CH₂)₄—* | CH₃—* | 1~60 | *—Si(CH₃)₂—(CH₂)₂—* | CH₃—* |
| (h-I-74) | C₂H₅O—* | *—(CH₂)₄—* | CH₃—* | 1~60 | *—Si(CH₃)₂—(CH₂)₃—* | CH₃—* |
| (h-I-75) | C₂H₅O—* | *—(CH₂)₄—* | CH₃—* | 1~60 | *—Si(CH₃)₂—(CH₂)₄—* | CH₃—* |

TABLE 6-2

| | A^{h10} | Z^{h10} | R^{h10} | h10 | Y^{h10} | R^{h10} |
|---|---|---|---|---|---|---|
| (h-I-76) | CH₃O—* | *—O—* | CH₃—* | 1~60 | — | CH₃—* |
| (h-I-77) | CH₃O—* | *—O—* | CH₃—* | 1~60 | *—Si(CH₃)₂—CH₂—* | CH₃—* |
| (h-I-78) | CH₃O—* | *—O—* | CH₃—* | 1~60 | *—Si(CH₃)₂—(CH₂)₂—* | CH₃—* |
| (h-I-79) | CH₃O—* | *—O—* | CH₃—* | 1~60 | *—Si(CH₃)₂—(CH₂)₃—* | CH₃—* |
| (h-I-80) | CH₃O—* | *—O—* | CH₃—* | 1~60 | *—Si(CH₃)₂—(CH₂)₄—* | CH₃—* |
| (h-I-81) | CH₃O—* | *—CH₂—* | CH₃—* | 1~60 | — | CH₃—* |
| (h-I-82) | CH₃O—* | *—CH₂—* | CH₃—* | 1~60 | *—Si(CH₃)₂—CH₂—* | CH₃—* |
| (h-I-83) | CH₃O—* | *—CH₂—* | CH₃—* | 1~60 | *—Si(CH₃)₂—(CH₂)₂—* | CH₃—* |
| (h-I-84) | CH₃O—* | *—CH₂—* | CH₃—* | 1~60 | *—Si(CH₃)₂—(CH₂)₃—* | CH₃—* |
| (h-I-85) | CH₃O—* | *—CH₂—* | CH₃—* | 1~60 | *—Si(CH₃)₂—(CH₂)₄—_{*} | CH₃—* |
| (h-I-86) | CH₃O—* | *—(CH₂)₂—* | CH₃—* | 1~60 | — | CH₃—* |
| (h-I-87) | CH₃O—* | *—(CH₂)₂—* | CH₃—* | 1~60 | *—Si(CH₃)₂—CH₂—* | CH₃—* |
| (h-I-88) | CH₃O—* | *—(CH₂)₂—* | CH₃—* | 1~60 | *—Si(CH₃)₂—(CH₂)₂—* | CH₃—* |
| (h-I-89) | CH₃O—* | *—(CH₂)₂—* | CH₃—* | 1~60 | *—Si(CH₃)₂—(CH₂)₃—_{*} | CH₃—* |
| (h-I-90) | CH₃O—* | *—(CH₂)₂—* | CH₃—* | 1~60 | *—Si(CH₃)₂—(CH₂)₄—* | CH₃—* |
| (h-I-91) | CH₃O—* | *—(CH₂)₃—* | CH₃—* | 1~60 | — | CH₃—* |
| (h-I-92) | CH₃O—* | *—(CH₂)₃—* | CH₃—* | 1~60 | *—Si(CH₃)₂—CH₂—* | CH₃—* |
| (h-I-93) | CH₃O—* | *—(CH₂)₃—* | CH₃—* | 1~60 | *—Si(CH₃)₂—(CH₂)₂—_{*} | CH₃—* |
| (h-I-94) | CH₃O—* | *—(CH₂)₃—* | CH₃—* | 1~60 | *—Si(CH₃)₂—(CH₂)₃—* | CH₃—* |
| (h-I-95) | CH₃O—* | *—(CH₂)₃—* | CH₃—* | 1~60 | *—Si(CH₃)₂—(CH₂)₄—* | CH₃—* |
| (h-I-96) | CH₃O—* | *—(CH₂)₄—* | CH₃—* | 1~60 | — | CH₃—* |
| (h-I-97) | CH₃O—* | *—(CH₂)₄—* | CH₃—* | 1~60 | *—Si(CH₃)₂—CH₂—* | CH₃—* |
| (h-I-98) | CH₃O—* | *—(CH₂)₄—* | CH₃—* | 1~60 | *—Si(CH₃)₂—(CH₂)₂—* | CH₃—* |
| (h-I-99) | CH₃O—* | *—(CH₂)₄—* | CH₃—* | 1~60 | *—Si(CH₃)₂—(CH₂)₃—* | CH₃—* |
| (h-I-100) | CH₃O—* | *—(CH₂)₄—* | CH₃—* | 1~60 | *—Si(CH₃)₂—(CH₂)₄—* | CH₃—* |

In Tables 5-1, 5-2, 6-1, and 6-2 above, h10 is more preferably an integer of 2 or more, still more preferably an integer of 3 or more and more preferably an integer of 50 or less, still more preferably an integer of 40 or less, further preferably an integer of 30 or less, and most preferably an integer of 25 or less.

The siloxane chain-including compound (H) is preferably compounds represented by formula (h3) below and formula (h4) below.

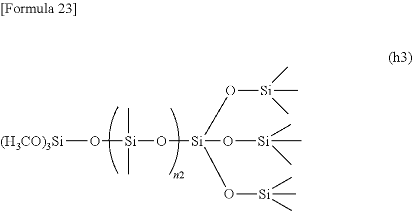

[In formula (h3), n2 is an integer of 1 to 60.]

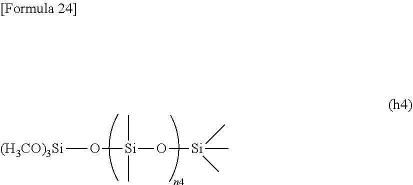

[In formula (h4), n4 is an integer of 1 to 60.]

The symbols n2 and n4 are more preferably an integer of 2 or more and still more preferably an integer of 3 or more and more preferably an integer of 50 or less, still more preferably an integer of 45 or less, further preferably an integer of 30 or less, and especially preferably an integer of 25 or less.

Coating properties at the time of bringing the composition into contact with a base material are improved by using a predetermined amount of the siloxane chain-including compound (H).

As a synthesis method for the siloxane chain-including compound (H), the method described in Japanese Patent Laid-Open No. 2017-201009 is given.

When the siloxane chain-including compound (H) is used for the mixed composition (q), an amount thereof is preferably 0.005% by mass or more, more preferably 0.01% by mass or more, still more preferably 0.03% by mass or more and preferably 0.3% by mass or less, more preferably 0.2% by mass or less, and still more preferably 0.15% by mass or less, with the total amount of the mixed composition (q) taken as 100% by mass, for example.

When the siloxane chain-including compound (H) is used for the mixed composition (q), a total amount of the polysilazane (F) and the siloxane chain-including compound (H) is preferably 0.01% by mass or more, more preferably 0.1% by mass or more, and still more preferably 0.3% by mass or more and preferably 2.6% by mass or less, more preferably 2% by mass or less, still more preferably 1.5% by mass or less, and especially preferably 1% by mass or less, with the total amount of the mixed composition (q) taken as 100% by mass, for example.

When the polysilazane (F), the metal compound (G), and the siloxane chain-including compound (H) are used for the mixed composition (q), a total amount thereof is preferably 0.3% by mass or more, more preferably 0.4% by mass or more, and still more preferably 0.5% by mass or more and preferably 5% by mass or less, more preferably 3% by mass or less, and still more preferably 1.5% by mass or less, with the total amount of the mixed composition (q) taken as 100% by mass, for example.

### 9. Solvent (I)

A solvent (I) is preferably used for the mixed composition (q).

Examples of the solvent (I) include an alcohol-based solvent, an ether-based solvent, a ketone-based solvent, an ester-based solvent, an amide-based solvent, an aliphatic hydrocarbon-based solvent, an aromatic hydrocarbon-based solvent, etc.

The alcohol-based solvent includes 1-propoxy-2-propanol, etc. in addition to the solvents exemplified as the solvent (E).

The ether-based solvent includes dibutylether, etc. in addition to the solvents exemplified as the solvent (E).

The ketone-based solvent includes the solvents exemplified as the solvent (E).

The ester-based solvent includes the solvents exemplified as the solvent (E).

The amide-based solvent includes the solvents exemplified as the solvent (E).

Examples of the aliphatic hydrocarbon-based solvent include pentane, hexane, heptane, octane, isooctane, cyclopentane, cyclohexane, cycloheptane, methylcyclohexane, mineral spirit, etc.

Examples of the aromatic hydrocarbon-based solvent include benzene, toluene, xylene, chlorobenzene, dichlorobenzene, etc.

Among them, a ketone-based solvent, an ether-based solvent, an ester-based solvent, and an aliphatic hydrocarbon-based solvent are preferable, and an aliphatic hydrocarbon-based solvent is more preferable. One kind of these solvents may be used, or two or more kinds thereof may be used by mixing appropriately. It is preferable that the solvent (I) does not contain moisture, because stability of a coating liquid can be enhanced and coating blur and foreign matters during coating can be reduced.

An amount of the solvent (I) is preferably 50% by mass or more, more preferably 80% by mass or more, still more preferably 90% by mass or more, and especially preferably 95% by mass or more, with the total amount of the mixed composition (q) taken as 100% by mass. An upper limit is set according to the amounts of the polysilazane (F), metal compound (G), siloxane chain-including compound (H), and other additive components (hereinafter referred to as the third component), and the solvent (I) may be the residue other than the polysilazane (F), metal compound (G), siloxane chain-including compound (H), and third component.

A catalyst may coexist with the mixed composition (q).

The catalyst is not particularly limited as long as it is a catalyst capable of curing the polysilazane (F) but includes an N-heterocyclic compound such as 1-methylpiperazine, 1-methylpiperidine, 4,4′-trimethylenedipiperizine, 4,4′-trimethylenebis(1-methylpiperidine), diazabicyclo[2.2.2]octane, cis-2,6-dimethylpiperazine, 4-(4-methylpiperidine)pyridine, pyridine, dipyridine, α-picoline, β-picoline, γ-picoline, piperidine, lutidine, pyrimidine, pyridazine, 4,4′-trimethylenedipyridine, 2-(methylamino)pyridine, pyradine, quinoline, quinoxaline, triazine, pyrrole, 3-pyrroline, imidazole, triazole, tetrazole, and 1-methylpyrrolidine, for example; an amine such as methylamine, dimethylamine, trimethylamine, ethylamine, diethylamine, triethylamine, propylamine, dipropylamine, tripropylamine, butylamine, dibutylamine, tributylamine, pentylamine, dipentylamine, tripentylamine, hexylamine, dihexylamine, trihexylamine, heptylamine, diheptylamine, octylamine, dioctylamine, trioctylamine, phenylamine, diphenylamine, and triphenylamine, for example; 1,8-diazabicyclo[5.4.0]-7-undecene (DBU), 1,5-diazabicyclo[4.3.0]-5-nonene (DBN), 1,5,9-triazacyclododecane, and 1,4,7-triazacyclononane, for example; etc.

In addition, a catalyst acting as a hydrolysis and condensation catalyst for the hydrolyzable group bonded to a silicon atom is also preferable as the catalyst, besides the above-described catalysts, and examples of such a catalyst include an acidic compound; a basic compound; an organic metal compound; etc. Examples of the acidic compound include an inorganic acid such as hydrochloric acid, nitric acid, sulfuric acid, phosphoric acid, hydrogen peroxide, chloric acid, and hypochlorous acid; an organic acid such as acetic acid, propionic acid, butyric acid, valeric acid, maleic acid, and stearic acid; etc. Examples of the basic compound include ammonia, etc. Examples of the organic metal compound include an organic metal compound with a central metal which is a metal element such as Al, Fe, Zn, and Sn and include an organic aluminum compound such as an aluminum carboxylate, aluminum acetylacetonate complex, and aluminum ethylacetoacetate complex; an organic iron compound such as an iron carboxylate (iron octylate); an organic zinc compound such as zinc acetylacetonato monohydrate, zinc naphthenate, and zinc octylate; an orgnic tin compound such as dibutyltindiacetate complex; and as other organic metal compounds, a metal carboxylate including Ni, Ti, Pt, Rh, Co, Ru, Os, Pd, Ir, etc.; an acetylacetonate complex including Ni, Pt, Pd, Rh, etc.; metal fine particles of Au, Ag, Pd, Ni, Zn, Ti, etc.; a metal peroxide; a metal chloride; a cyclopentadienyl metal complex such as ferrocene and zirconocene; etc.

The same additives as those for the mixed composition (p) described above are optionally allowed to coexist also in the mixed composition (q) within a range not impairing the effect of the present invention.

### EXAMPLES

Hereinafter, the present invention will be specifically described with reference to examples. The present invention is not limited by the following examples and can be also carried out with a modification made within the range compatible with the gist described above and below, and all of them are encompassed by the technical scope of the present invention.

Preparation of Mixed Composition (q)—No. 1q

Mixed composition (q)—No. 1q was obtained by dissolving 0.5% by mass of Durazane (R) 1500 rapid cure (manufactured by MERCK KGaA) (polysilazane (F)), 0.3% by mass of tetraethoxysilane (metal compound (G)), and 0.05% by mass of a compound in which the average of h10 was 24 in (h-I-26) shown in Table 5-2 above (hereinafter, denoted by compound (1)) (siloxane chain-including compound (H)) in 99.15% by mass of isooctane (solvent (I)).

Incidentally, Durazane 1500 rapid cure has structural units represented by the following formula (f4) below.

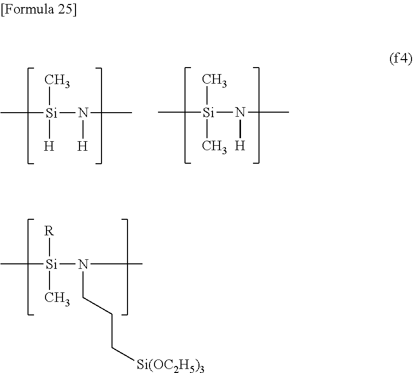

In formula (f4) above, R represents a hydrogen atom or a methyl group.

Durazane 1500 rapid cure (manufactured by MERCK KGaA) had 9% to 27% by mass of Si(OC₂H₅)₃ groups, and the mole ratio (methyl group/hydrogen atom) between hydrogen atoms of SiH groups and methyl groups of Si—CH₃ groups in the structure in (f4) above was both 2.39. The mass ratio of the Si(OC₂H₅)₃ groups and the mole ratio between hydrogen atoms and methyl groups were defined on the basis of integral values in 1H-NMR (400 MHz, reference: CDCl₃ (=7.24 ppm)). That is, mole ratios of SiH, SiCH₃, and Si(OCH₂CH₃)₃ in the organic polysilazane were obtained from the integral values, and the mole ratio between hydrogen atoms and methyl groups was calculated. In addition, they were respectively converted to mass ratios, and the mass % of Si(OC₂H₅)₃ groups included in the organic polysilazane was calculated.

Preparation of Mixed Composition (p)—No. 1p

Compound (1) (organic silicon compound (A)) above and triethoxysilane (organic silicon compound (B)) were dissolved in isopropyl alcohol (solvent (E)), followed by stirring at room temperature for 10 minutes. Acetic acid (catalyst (C)) and water (water (D)) were dropped into the obtained solution, and the solution was then stirred at 65° C. for two hours to obtain sample solution 1. Obtained sample solution 1 was diluted by isopropyl alcohol to prepare a mixed composition (p)—No. 1p. The proportion (mass %) of each compound in the mixed composition (p)—No. 1p is as described in Table 7 below (the same applied to the other examples and comparative example).

Preparation of Mixed Composition (p)—Nos. 2p to 7p

The mixed composition (p)—Nos. 2p to 7p were prepared in the same manner as the mixed composition (p)—No. 1p except that the kinds and/or amounts of the organic silicon compound (A), metal compound (B), catalyst (C), water (D), and solvent (E) were changed as shown in Table 7 below in the mixed composition (p)—No. 1p. In the table, compound (2) is the compound represented by the following formula.

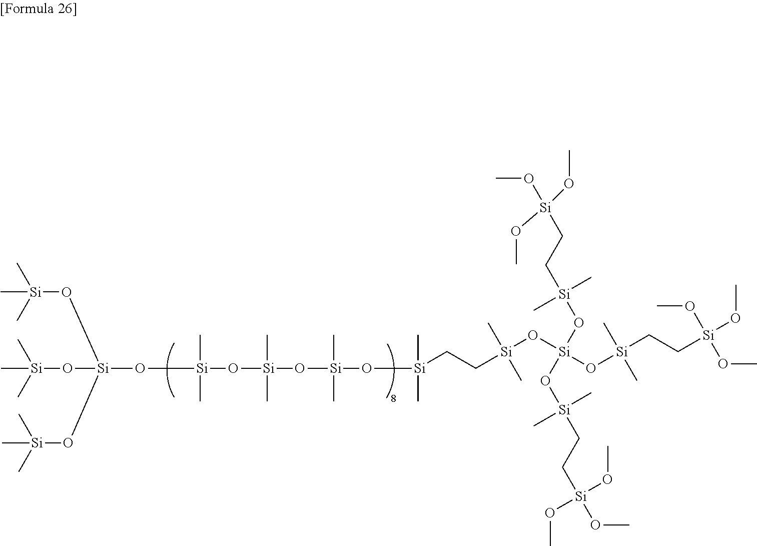

TABLE 7

| Composition No. | | | | 1 p | 2 p | 3 p | 4 p | 5 p | 6 p | 7 p |
|---|---|---|---|---|---|---|---|---|---|---|
| Mixed | Organic silicon | Compound 1 | Mass % | 0.029 | 0.029 | 0.029 | 0.062 | 0.098 | 0.029 | 0.031 |
| composition | compound (A) | Compound 2 | Mass % | | | | | | | |
| (p) | Organic silicon | Tetraethoxysilane | Mass % | | | | | | | 0.075 |
| | compound (B) | Triethoxysilane | Mass % | 0.077 | 0.076 | 0.076 | 0.161 | 0.255 | 0.075 | |
| | Catalyst (C) | Acetic acid | Mass % | 16 × 10⁻⁴ | 16 × 10⁻⁴ | 16 × 10⁻⁴ | 35 × 10⁻⁴ | 55 × 10⁻⁴ | 16 × 10⁻⁴ | |
| | | Maleic acid | Mass % | | 15 × 10⁻³ | 80 × 10⁻³ | 17 × 10⁻² | 27 × 10⁻² | 17 × 10⁻² | 54 × 10⁻³ |
| | Water (D) | | Mass % | 0.027 | 0.027 | 0.027 | 0.057 | 0.091 | 0.027 | 0.022 |
| | Solvent (E) | Isopropyl alcohol | Mass % | 99.87 | 99.87 | 99.87 | 99.72 | 99.56 | 99.87 | 99.87 |

Coating film No. 1

A glass substrate of 5×5 cm² (EAGLE XG manufactured by Corning Incorporated) with the surface thereof activated by atmospheric pressure plasma treatment was placed so that the elevation angle became 45°, and 500 μL of the mixed composition (q)—No. 1q was poured to the top surface of the glass substrate, followed by drying at ordinary temperature and ordinary humidity for five minutes. A coating film was formed on the glass substrate by further pouring 500 μL of the mixed composition (p)—No. 1p above the top surface of the glass substrate, followed by air drying at ordinary temperature and ordinary humidity for one day.

### Coating Films Nos. 2 to 7

With respect to the coating films Nos. 2 to 7 (Examples), 500 μL of the mixed composition (q)—No. 1q was poured to the top surface of a glass substrate under the same conditions as the coating film No. 1, followed by drying at ordinary temperature and ordinary humidity for five minutes. A coating film was formed on the glass substrate by further pouring 500 μL of each of the mixed compositions (p) Nos. 2p to 7p above the top surface of the glass substrate, followed by air drying at ordinary temperature and ordinary humidity for one day.

### Coating Film No. 8

With respect to a coating film No. 8 (Comparative Example), a mixed composition in which 1.5% by mass of mono-terminal reactive silicone oil (X-24-9011, manufactured by Shin-Etsu Chemical Co., Ltd.) (siloxane chain-including compound (H)) and 5% by mass of Durazane (R) 1500 rapid cure (manufactured by MERCK KGaA) (polysilazane (F)) were dissolved in 93.5% by mass of isooctane (solvent (I)) was dropped on a glass substrate, and a film was formed, by a spin-coater (manufactured by MIKASA CO., LTD), under the conditions of a rotation speed of 3000 rpm for 20 seconds, which was then left to stand at ordinary temperature and ordinary humidity for one day to form the coating film No. 8.

The obtained coating films were evaluated and measured by the following method.

### (1) Measurement of Density and Film Thickness of Each Layer

An automated multipurpose X-ray diffractometer (SmartLab) manufactured by Rigaku Corporation was used for measurement. As an X-ray source, an X-ray generating device with 45 kW and a wavelength of X=0.15418 nm of CuKα line or a wavelength of X=0.15406 nm of CuKα1 line by a Cu target were used, and a monochromator was not used or a monochromatic crystal Ge(220) was used. As setting conditions, a sampling width of 0.010 or 0.0020 and a scanning range of 0.0° to 2.5° or 0.00 to 1.6° were set. Then, measurement was carried out under the above setting conditions to obtain reflective index measurement values. The obtained measurement values were analyzed using analysis software (GlobalFit) from the same company. More specifically, the film thickness, density and components of each layer were determined by initializing parameters of the thickness, density, and components, and fitting a simulation operation profile obtained by changing at least one or more of these parameters so as to match an actually measured profile.

### (2) Contact Angle

A contact angle with respect to water on the coating film surface was measured using contact angle measurement device “DM700” manufactured by Kyowa Interface Science Co., Ltd. with a water drop amount of 3.0 μL and θ/2 method as an analysis method. A contact angle after a flowing water test described later was measured in the same manner.

### (3) Slipping Speed

Water was dropped on the coating film surface, and water repellency was evaluated from the slipping speed of the water drop on the coating film surface. Specifically, using contact angle measurement device “DM700” manufactured by Kyowa Interface Science Co., Ltd., 50 μL of water was dropped onto the coating film surface on a glass substrate inclined at 20°, a time taken for the water drop to slip 15 mm from the initial dropping position, and the slipping speed (mm/second) of the water drop on the coating film surface was calculated. The slipping speed of the water drop was measured in the same manner for a slipping speed after a flowing water test described later.

### (4) Wear Resistance

Onto the coating film, 2.5 mL of water was dropped, and a silicone sheet (SR-400 manufactured by Tigers Polymer Corporation) was brought into contact therewith from above. Then, the silicone sheet and the coating film were rubbed over a distance of 20 mm in increments of 400 cycles under the condition of a reciprocation speed of 400 mm per minute, with a load of 500 g applied from above the silicone sheet, contact angles at three points in the central part of the worn part were respectively measured, and the number of cycles until the contact angles at two points out of the three points decreased to 850 or less was measured.

(5) Measurement of Silanol Group Amount after Flowing Water Test

### Method for Flowing Water Test

A coating film applied onto a glass substrate was kept at an angle of 150 in a salt spray test instrument (manufactured by Suga Test Instruments Co., Ltd., model: STP-90V-4). According to JIS Z2371A, a flowing water test was carried out by exposing the coating film to pure water for 24 hours using pure water instead of salt water.

### Silanol Group Amount Measurement Method

A coating film applied onto a glass substrate was kept at right angle in a glass cup with a lid. The coating film was exposed to trifluoroacetic anhydride steam by putting 2 mL of trifluoroacetic anhydride into the bottom of the glass cup in such a manner that trifluoroacetic anhydride does not contact with the coating film and leaving to stand still at 40° C. for one hour. After the coating film was taken out, vacuum drying under reduced pressure was carried out for 12 hours. The coating film after vacuum drying under reduced pressure was measured by the X-ray photoelectron spectroscopy (XPS) described below to quantify the amount of silanol groups on the surface of the coating film as a fluorine amount. As the stoichiometric reaction ratio between trifluoroacetic anhydride reacting with silanol groups and silanol groups is 3:1, the amount of silanol groups was calculated from the fluorine amount obtained by measurement.

### XPS Measurement Conditions

JFS-9010 series manufactured by JEOL Ltd. was used for XPS measurement. Measurement was conducted on various elements including fluorine (F1s), oxygen (O1s), carbon (C1s), and silicon (Si2/3) using MgKα as an excitation X-ray, with X-ray output of 110 W, a photoelectron take-off angle of 30°, and a pass energy of 10 eV. Furthermore, while charge correction for chemical shifts in the measured spectrum can be carried out with various standard samples and the like, the spectrum from carbon C1s was corrected as an energy reference 284 eV in this case.

### (6) Oil Repellency Evaluation

As a method for evaluating oil repellency, a circle was drawn on the coating film using a magic marker (PEN-TOUCH, oil-based, medium line width, manufactured by SAKURA COLOR PRODUCTS CORPORATION), and the circle was subsequently wiped out by savina (R) wiping cloth. The case where the magic marker mark could be wiped out was rated as good, and the case where the magic marker mark could not be wiped out was rated as poor. The fact that magic marker mark could be wiped out indicates that oil repellency is also good.

Results are shown in Table 8.

TABLE 8

| | | | | | | | | | | Comparative |
|---|---|---|---|---|---|---|---|---|---|---|
| | | | Examples | | | | | | | Example |
| Coating film No. | | | 1 | 2 | 3 | 4 | 5 | 6 | 7 | 8 |
| Mixed composition (p) No. | | | 1 p | 2 p | 3 p | 4 p | 5 p | 6 p | 7 p | Composition for |
| Mixed composition (q) No. | | | 1 q | 1 q | 1 q | 1 q | 1 q | 1 q | 1 q | forming coating |
| | | | | | | | | | | film No.8 |
| Thickness nm | | Layer (M) | 5.35 | 2.54 | 3.02 | 5.50 | 3.40 | 2.73 | 5.40 | 11.7 |
| | | Layer (K1) | 1.010 | 11.01 | 6.30 | 16.80 | 22.24 | 3.49 | 8.47 | 35.76 |
| | | Layer (K2) | 5.58 | 4.81 | 4.22 | 6.41 | 19.92 | 3.78 | 5.04 | |
| | | Total | 21.03 | 18.36 | 13.54 | 28.71 | 45.56 | 10.00 | 18.91 | 47.46 |
| Density | | Layer (M) | 0.96 | 0.81 | 0.85 | 0.85 | 0.82 | 0.84 | 0.97 | 0.48 |
| g/cm³ | | Layer (K1) | 1.25 | 1.02 | 1.20 | 1.58 | 1.12 | 1.02 | 1.34 | 0.67 |
| | | Layer (K2) | 0.83 | 0.72 | 0.83 | 1.10 | 1.04 | 0.86 | 0.85 | |
| SiOH amount after | | mol % | 0.67 | 0.48 | 0.41 | 0.32 | 0.31 | 0.46 | 0.44 | 0.85 |
| flowing water test | | | | | | | | | | |
| Initial | Contact angle | ° | 102.1 | 102.1 | 103.4 | 105.1 | 104.1 | 102.0 | 100.9 | 95.1 |
| | Slipping speed | mm/sec | 49.0 | 51.8 | 48.6 | 81.1 | 51.9 | 54.3 | 35.1 | 7.8 |
| | Wear | Cycles | 1200 | 2400 | 2000 | 800 | 800 | 1600 | 2800 | 400 |
| | resistance | | | | | | | | | |
| | cycles | | | | | | | | | |
| | Oil repellency | | Good | Good | Good | Good | Good | Good | Good | Good |
| After flowing | Contact angle | ° | 97.1 | 98.1 | 98.3 | 96.0 | 101.1 | 100.9 | 100.0 | 89.1 |
| water test | Slipping speed | mm/sec | 29.4 | 25.4 | 23.6 | 68.8 | 32.6 | 40.8 | 43.7 | 3.3 |

In addition, the fitting processing described above was carried out by initializing as follows: the layer (M) is a layer formed from compound (1) or compound (2), that is, a layer having a dimethylsiloxane skeleton; the layer (K1) is a layer having a siloxane structure; and the layer (K2) is a layer formed from the organic polysilazane used, that is, a layer having a silicon atom to which a nitrogen atom and a silicon atom with a methyl group bonded thereto are bonded.

The coating films Nos. 1-7, which are working examples, were excellent in wear resistance since they were coating layers having: a layer (M) having a density of 0.7 g/cm³ or more and less than 1.0 g/cm³; and a layer (K1) being in contact with the layer (M) and having a density of 1.0 g/cm³ or more and less than 2.2 g/cm³. On the other hand, in the coating film No. 8 which did not use the mixed compositions (p) and (q), the densities of the outermost surface and its adjacent layer both did not satisfy the density ranges for the layer (M) and the layer (K1) according to the present invention, and wear resistance was poor.

### INDUSTRIAL APPLICABILITY

The coating film obtained by using the composition for forming a water-repellent layer according to the present invention is excellent in water repellency, oil repellency, and wear resistance. Therefore, base materials having been processed using the composition for forming a water-repellent layer according to the present invention is useful as base materials for display devices such as a touch panel display, optical elements, semiconductor elements, building materials, automobile components, nanoimprint technique, etc. In addition, coating films formed from the composition for forming a water-repellent layer according to the present invention are preferably used as articles such as bodies, glass for windows (windshields, side windows, rear windows), mirrors, and bumpers in transporting devices such as electric trains, automobiles, watercrafts, and aircrafts. In addition, the coating films can also be used for outdoor use such as building exterior walls, tents, solar power generation modules, sound insulation plates, and concrete. In addition, the coating films can also be used for fishing nets, insect nets, aquariums, etc. Furthermore, the coating films can also be utilized for various interior facilities such as kitchens, bath rooms, washstands, mirrors, and articles for each member around toilets, chandeliers, ceramics such as tiles, artificial marble, and air conditioners. In addition, the coating films can also be used as antifouling treatment for jigs, inner walls, pipes, etc. in factories. In addition, the coating films are also suitable for goggles, glasses, helmets, pachinko, fibers, umbrellas, playground equipment, soccer balls, etc. Furthermore, the coating films can also be used as an adhesion inhibitor for various packaging materials such as packaging materials for food, packaging materials for cosmetics, and the inside of pots.

1. A coating film having at least an outermost surface layer (M) and a layer (K1) in contact with the layer (M), wherein a density of the layer (M) is 0.7 g/cm³ or more and less than 1.0 g/cm³, and a density of the layer (K1) is 1.0 g/cm³ or more and less than 2.2 g/cm³.

2. The coating film according to claim 1, wherein the layer (M) has a polydimethylsiloxane skeleton.

3. The coating film according to claim 1, wherein the layer (M) has a trialkylsilyl group.

4. The coating film according to claim 1,
further having a layer (K2), wherein
the layer (K2) is in contact with a side of the layer (K1) opposite to the layer (M), and a density of the layer (K2) is 1.1 g/cm³ or less and is smaller than the density of the layer (K1).

5. The coating film according to claim 2, having a polydimethylsiloxane skeleton, wherein silanol groups present on a surface of the coating film after a flowing water test conducted in accordance with JIS Z2371 except that pure water is used instead of salt water is 5 mol % or less based on elements on an outermost surface of the coating film.

6. The coating film according to claim 1, wherein a total thickness of the layer (M) and the layer (K1) is 5 nm or more and 100 nm or less.

7. A layered body comprising the coating film according to claim 1 formed on a base material (S).

8. A method for manufacturing a layered body comprising a layer (K1) having a density of 1.0 g/cm³ or more and less than 2.2 g/cm³ formed on a base material (S), and a layer (M) having a density of 0.7 g/cm³ or more and less than 1.0 g/cm³ formed, in contact with the layer (K1), on an outermost surface of the layered body, the method comprising:
applying a mixed composition (q) of a polysilazane (F) on the base material (S); before or during curing of the mixed composition (q),
applying a mixed composition (p) of an organic silicon compound (A) having at least one trialkylsilyl group and one or more hydrolyzable silicon groups, an organic silicon compound (B) in which at least one hydrolyzable group is bonded to a silicon atom, and water (C) to a surface coated with the mixed composition (q); and
curing the mixed composition (q) and the mixed composition (p) to form the layer (M) and layer (K1) from a coating layer of the mixed composition (p).
